(19) United States
(12) Patent Application Publication
(10) Pub. No.: US 2011/0278849 A1
(43) Pub. Date: Nov. 17, 2011

(54) Dynamo, Current Turbine System and its Installation and Maintenance Method

(76) Inventor: Teng-Yi Huang, Chiayi City (TW)

(21) Appl. No.: 13/106,406

(22) Filed: May 12, 2011

(30) Foreign Application Priority Data
May 13, 2010 (TW) 099115210

(51) Int. Cl. F03B 13/10; E02D 5/74

(52) U.S. Cl. 290/54; 405/224

(57) ABSTRACT

The dynamo, current turbine system and its installation and maintenance method are provided. The current turbine system comprises at least one dynamo; wherein each one of dynamo contains a rotor unit, at least one stator unit and at least one space. The rotor unit has rotative axis approximately perpendicular to the flow direction; pluralities of disturbing elements are disposed outside so that drag force relative to the current flow is formed; the rotor unit is driven to rotate when the current flow passes through the disturbing elements; the space is disposed inside the rotor unit; whereby the current turbine system may be suspended underwater. The installation and maintenance method may conveniently install or maintain the dynamo or the current turbine system with economic cost.

### FIELD OF THE INVENTION

The present invention relates to a dynamo, a current turbine system and an installation and maintenance method for the dynamo or for the current turbine system, particularly relates to the dynamo with greater electricity generated and relates to the current turbine system suspended underwater by means of buoyant force, cable, halyard or anchor.

### DESCRIPTION OF THE PRIOR ART

Energy is vital important resource to human for every aspect, such as illumination, transportation, air conditioning and all of human's living activities. Sadly, the energy may be consumed someday. And the renewable energies, e.g. solar energy, biomass energy, tidal energy or sea current energy, have some limitations remained, including high cost for development or far from utilization. In this reason, it is impossible that the renewable energies could be mass practiced so as to replace those consumed energies. Moreover, the fossil fuel is the most critical energy source in these decades, but it not only brings devastating global warming problem but also can be exhausted someday. In this manner, development for better and cheaper renewable energy in order to substitute fossil fuel and relieve the global warming is indeed an urgent issue.

Among those renewable energies, sea current turbine could be a promising one because of its relatively developed dynamo technology. The advantages for electricity generation by means of sea current are: steady and stable sea flow, sufficient kinetic energy for driving the dynamo, non pollution and never-depletion resource. Thus it is assumed that the sea current energy seems likely to have extremely potential for taking effect. However, because of the water erosion and installation or maintenance difficulty, the underwater dynamo is too expansive to install. Hence there is no existing current turbine system or underwater dynamo available in the meantime.

So how to maximize the electricity generated so as to balance the installation and maintenance cost of the sea current turbine system, or address the problem of installing and maintaining the dynamo beneath the sea level are critical issues needed to be settled.

### SUMMARY OF THE INVENTION

The primary object of present invention is to float the dynamo above the seabed, so as to economically, conveniently and quickly install and maintain the underwater dynamo, so that the difficulty for anchor engineering is hence resolved.

To achieve the foregoing and other objects, the current turbine system comprising at least one dynamo is provided. Each one of dynamo contains a rotor unit, at least one stator unit and at least one space. The rotor unit has rotative axis approximately perpendicular to the flow direction; pluralities of disturbing elements are disposed outside so that drag force relative to the current flow is formed; the rotor unit is driven to rotate when the current flow passes through the disturbing elements; the space is disposed inside the rotor unit; whereby the current turbine system may be suspended underwater.

To achieve the foregoing and other objects, a dynamo is provided. The dynamo comprises a rotor unit and a stator. The rotor unit contains at least one sub-rotor; the stator unit contains at least two sub-stators; wherein each sub-rotor is adjacent to at least one sub-stator and each sub-stator is adjacent to at least one sub-rotor.

To achieve the foregoing and other objects, an installation and maintenance method for installing and maintaining a current turbine system is provided. The current turbine system comprises at least one dynamo, at least one buoyant element, at least one fixing cable, at least one anchor structure and at least one halyard. The dynamo is able to float by means of the buoyant element; two ends of the fixing cable respectively connects to the dynamo and the anchor structure; one end of the halyard connects to a floating apparatus floated on the water surface; another end of the same halyard connects to the dynamo or connects to the anchor structure. The installation and maintenance method comprising the steps: moving the dynamo downward by means of the weight of the anchor structure; stopping the anchor structure from moving downward; whereby the dynamo is suspended underwater by means of the buoyant force and the pulling force of the fixing cable.

Whereby, the dynamo and current turbine system of present invention may maximize the generated electricity, and may be suspend underwater. The installation and maintenance method may conveniently install and maintain a current turbine system or dynamos with relatively lower cost, so as to prevent the problem of deep sea work and underwater maintenance.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is diagram of current turbine system according to the 1^{st} embodiment of present invention;

FIG. 1B is floating principle diagram of current turbine system according to the 1^{st} embodiment of present invention;

FIG. 2A is diagram of rotor unit according to the 2^{nd} embodiment of present invention;

FIG. 2B is diagram of rotor unit according to the 3^{rd} embodiment of present invention;

FIG. 3A is diagram of rotor unit according to the 4^{th} embodiment of present invention;

FIG. 3B is diagram of rotor unit according to the 5^{th} embodiment of present invention;

FIG. 3C is diagram of rotor unit according to the 6^{th} embodiment of present invention;

FIG. 4A is diagram of rotor unit according to the 7^{th} embodiment of present invention;

FIG. 4B is diagram of rotor unit according to the 8^{th} embodiment of present invention;

FIG. 5A is diagram of rotor unit according to the 9^{th} embodiment of present invention;

FIG. 5B is diagram of rotor unit according to the 10^{th} embodiment of present invention;

FIG. 5C is diagram of rotor unit according to the 11^{th} embodiment of present invention;

FIG. 6A˜6C are diagrams of dynamo according to the 12^{th} embodiment of present invention;

FIG. 7A˜7C are diagrams of dynamo according to the 13^{th} embodiment of present invention;

FIG. 8A˜8C are diagrams of dynamo according to the 14^{th} embodiment of present invention;

FIG. 8D is diagram of dynamo according to the 15^{th} embodiment of present invention;

FIG. 8E is diagram of dynamo according to the 16^{th} embodiment of present invention;

FIG. 9A˜9C are diagrams of dynamo according to the 17^{th} embodiment of present invention;

FIG. 9D is diagram of dynamo according to the 18^{th} embodiment of present invention;

FIG. 10A˜10C are diagrams of dynamo according to the 19^{th} embodiment of present invention;

FIG. 10D is diagram of dynamo according to the 20^{th} embodiment of present invention;

FIG. 11A is A-A sectional diagram of FIG. 11B;

FIG. 11B is diagram of dynamo according to the 21^{st} embodiment of present invention;

FIG. 12A is B-B sectional diagram of FIG. 12B;

FIG. 12B is diagram of dynamo according to the 22^{nd} embodiment of present invention;

FIG. 13 is diagram of dynamos according to the 23^{rd} embodiment of present invention;

FIG. 14 is diagram of dynamos according to the 24^{th} embodiment of present invention;

FIG. 15 is diagram of dynamos according to the 25^{th} embodiment of present invention;

FIG. 16 is diagram of dynamos according to the 26^{th} embodiment of present invention;

FIG. 17 is diagram of dynamos according to the 27^{th} embodiment of present invention;

FIG. 18 is diagram of dynamos according to the 28^{th} embodiment of present invention;

FIG. 19 is diagram of dynamos according to the 29^{th} embodiment of present invention;

FIG. 20 is diagram of dynamos according to the 30^{th} embodiment of present invention;

FIG. 21 is diagram of dynamos according to the 31^{st} embodiment of present invention;

FIG. 22 is diagram of dynamos according to the 32^{nd} embodiment of present invention;

FIG. 23 is diagram of dynamos according to the 33^{rd} embodiment of present invention;

FIG. 24 is diagram of dynamos according to the 34^{th} embodiment of present invention;

FIG. 25A˜25D are diagrams of installation and maintenance method for the current turbine system according to the present invention;

FIG. 26A˜26D are diagrams of another installation and maintenance method for the current turbine system according to the present invention;

FIG. 27 is flow chart of installation and maintenance method for the current turbine system according to the present invention;

FIG. 28A is diagram of dynamo according to the 35^{th} embodiment of present invention;

FIG. 28B is diagram of dynamo according to the 36^{th} embodiment of present invention;

FIG. 29A is diagram of dynamo according to the 37^{th} embodiment of present invention;

FIG. 29B is diagram of dynamo according to the 38^{th} embodiment of present invention;

FIG. 30A is diagram of dynamo according to the 39^{th} embodiment of present invention;

FIG. 30B is diagram of dynamo according to the 40^{th} embodiment of present invention;

FIG. 31 is diagram of dynamo according to the 41^{st} embodiment of present invention;

FIG. 32 is diagram of dynamo according to the 42^{nd} embodiment of present invention.

### DESCRIPTION OF THE PREFERRED EMBODIMENTS

### 1^{st} Embodiment

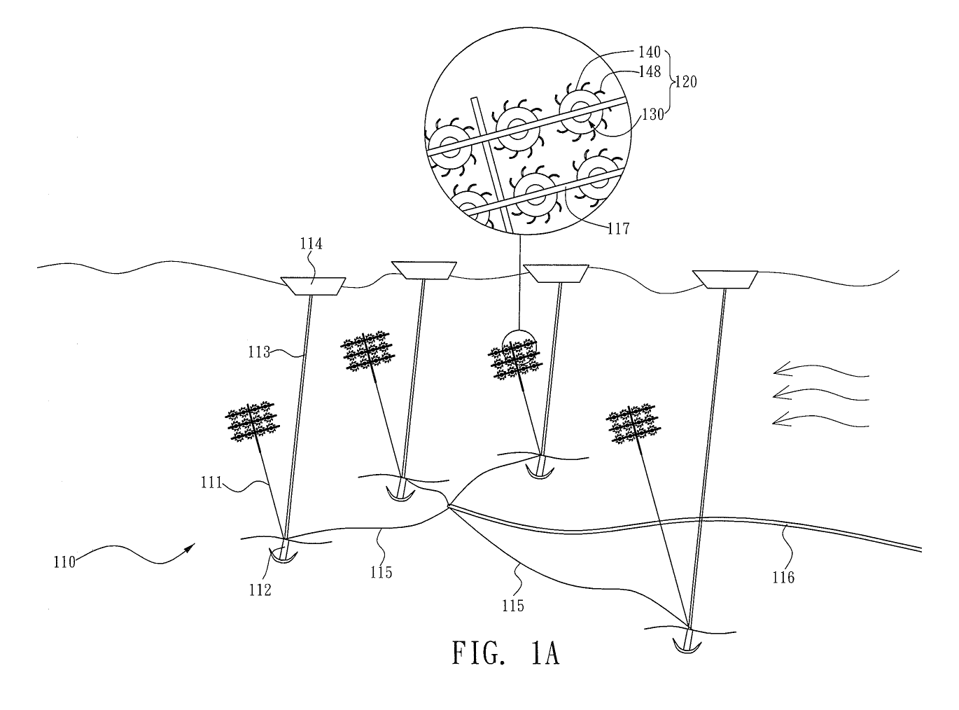

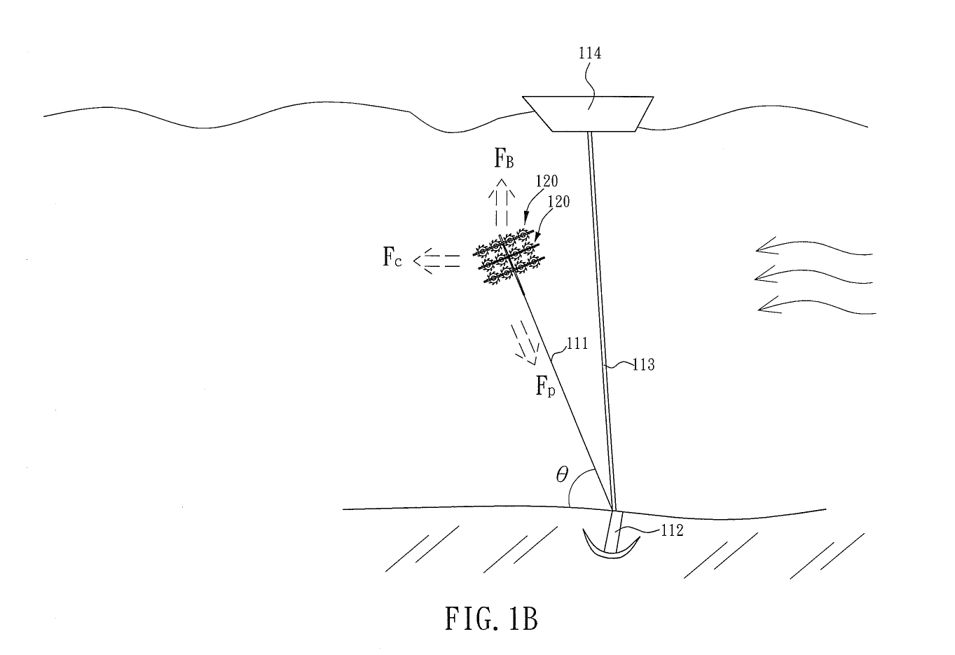

Please refer to FIG. 1A, FIG. 1A is diagram of current turbine system according to the 1^{st} embodiment of present invention. As shown in FIG. 1A, a current turbine system 110 comprises pluralities of dynamos 120, pluralities of fixing cables 111, pluralities of halyards 113, pluralities of submarine cables 115, pluralities of anchor structures 112 and pluralities of floating apparatuses 114. Each dynamo 120 contains a rotor unit 140 and a stator unit 130. Each rotor unit 140 contains pluralities of disturbing elements 148 disposed at outside of the rotor unit 140, so that drag force relative to the current flow is formed at neighboring of the disturbing elements 148 and therefore the rotor unit 140 is driven to rotate. In fluid mechanics, if the disturbing element 148 has curved face, then the drag force (e.g. form drag force) is normally formed between upstream and downstream when water current pass through the disturbing element 148. The drag force around the disturbing elements 148 may be utilized to push the rotor unit 140 and the disturbing elements 148 rotating continuously. As shown in FIG. 1A, the disturbing elements 148 are protruded blade. Besides, the water current flows leftward; the rotative axis (not marked) of the rotor unit 140 is perpendicular to the drawing plane (i.e. picture of paper); therefore the rotative axis is approximately perpendicular to the flow direction. Moreover, those dynamos 120 of the current turbine system 110 may be suspended underwater or floated above seabed by means of buoyant force, and the buoyant force generated is addressed later.

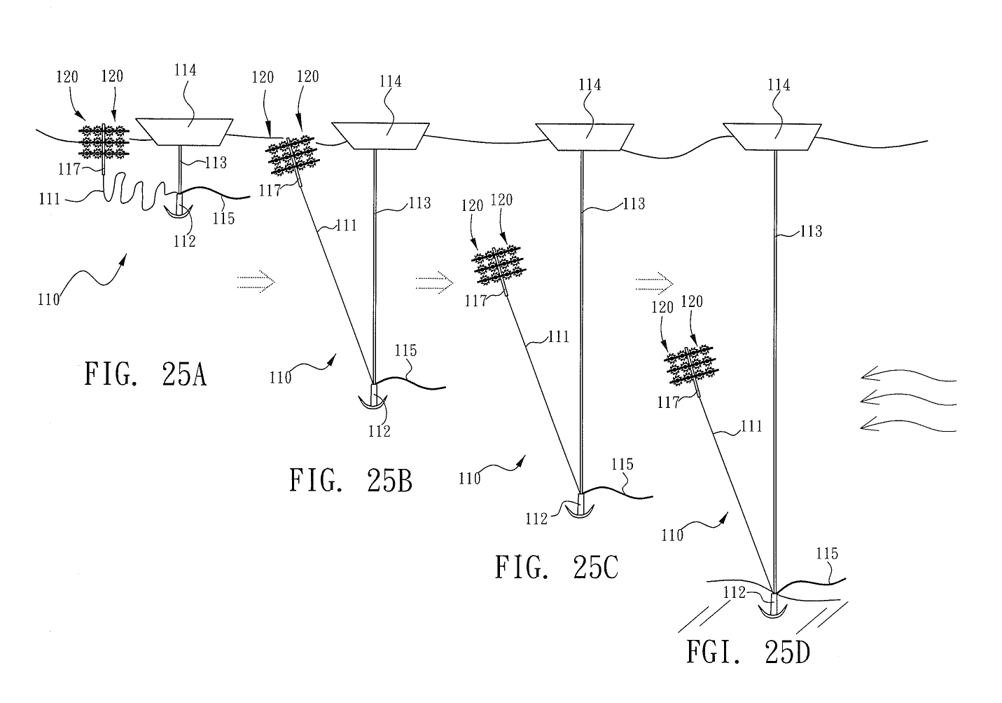

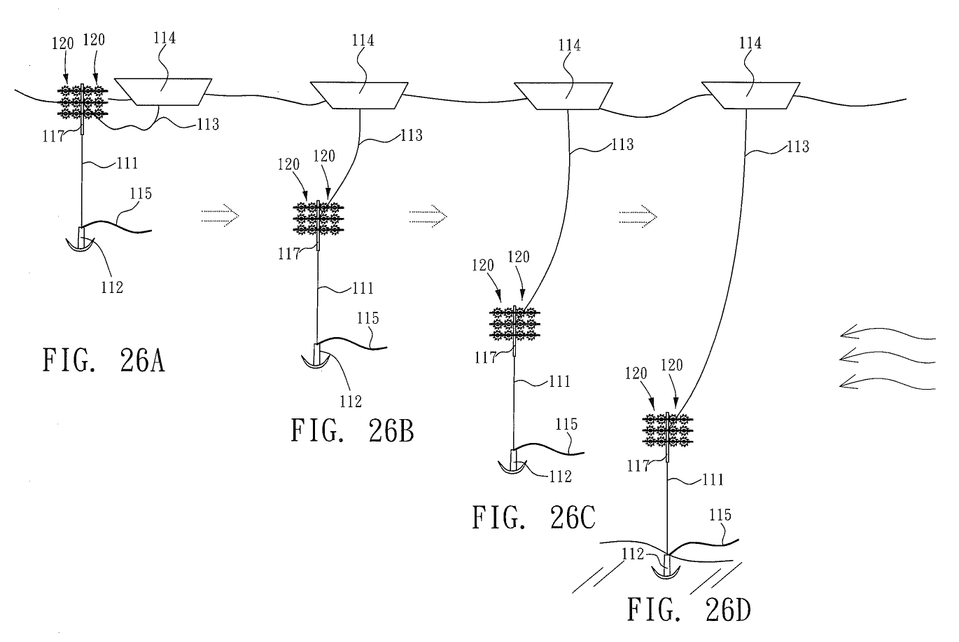

Each fixing cable 111 is connected to a submarine cable 115. As shown in enlarged diagram of FIG. 1A, twelve dynamos 120 are combined together by means of fixing those stator units 130 on a holder 117. In preferable case, the holder 117 and those stator units 130 could be one-body shaped (i.e. one piece); however, in some other cases the holder 117 and those stator units 130 could be separable configuration. Different type of coupling structures regarding the connection of the holder 117 and those dynamos 120 are also introduced later. Additionally, after electricity is generated from the dynamos 120, the holder 117 not only can fix those stator units 130 but also can conduct and transfer the electricity to the fixing cable 111, and hence the electricity may be conducted or transferred to the submarine cable 115 or a main cable 116, so that the electricity is ultimately conducted to the grid in land. One end of each fixing cable 111 is connected to at least one stator unit 130 by means of a holder 117; another end of the same fixing cable 111 is connected to the anchor structure 112 at bottom of water (could be seabed). In workable scenario, the anchor structure 112 could be stopped at any position above or at seabed. The anchor structure 112 may be utilized to balance the buoyant force of the dynamo 120 and the momentum (i.e. aforesaid drag force) of the water current. Namely, the dynamos 120 may be suspended without washing away by means of connection of the fixing cable 111 and weight of the anchor structure 112. In some embodiments, lower end of the fixing cable 111 could be fastened to seabed by means of other anchorage engineering or other configuration. One end of each halyard 113 is connected to a floating apparatus 114 floated on the water surface, and another end of the same halyard 113 is connected to one of anchor structures 112. The floating apparatus 114 could further contain a positioning system (not shown) or reel device disposed in; wherein the floating apparatus 114 could be boat, ship, dock, shipyard, yacht or any power motive device. The halyard 113 could conduct or transfer the generated electricity to the floating apparatus 114, so that electrolyzing water for oxygen, hydrogen or chemical compositions production may be carried out at the floating apparatus 114; besides, the generated electricity could also be supplied for power resource of aforesaid positioning system. Furthermore, the electrical properties (e.g. voltage, electric current or power) of the dynamo 120 could be measured and detected in the floating apparatus 114, through the halyard 113 or by means of the halyard 113. The halyard 113 could also have function of maintaining the dynamos 120. As shown in FIG. 25A˜25D, when the dynamo 120 needs maintenance, the halyard 113 may be pulled or rolled up, and then the anchor structure 112 may be moved upward by means of reel device (not shown) of the floating apparatus 114. As a result, the dynamos 120 may be floated and moved upward until the water surface by taking advantage of buoyant force. In this manner, the dynamos 120 may be repaired or maintained at the site of the floating apparatus 114. If the sea wave is devastated, the dynamos 120 might be berthed at the floating apparatus 114 and then wait for other maintenance vessel, or wait for hauling boat to draw the dynamos 120 to other place. Therefore the underwater maintenance or deep sea work is prevented. Besides, in preferable embodiment, the positioning system could be Global Positioning System (GPS), which contains wireless set, radio set, transceiver or receiver transmitter, so as to achieve marine navigation or positioning function for the floating apparatus 114. The GPS could obtain longitude and latitude coordinates and moving velocity of the floating apparatus 114 from the satellite immediately, so that the radio set or transceiver may transfer those positioning information outward; in this manner, exact location of the floating apparatus 114 is thus quickly detected by maintenance staff or mechanic in maintenance vessel or hauling boat. In other embodiment, as shown in FIG. 26A˜26D, lower end of the halyard 113 could be connected to one of the stator units 130 or one of the holders 117; when the halyard 113 is pulled or rolled up by means of the reel device (could be in floating apparatus 114), the dynamos 120 are hence moved upward.

Please refer to FIG. 1B, FIG. 1B is floating principle diagram of current turbine system according to the 1^{st} embodiment of present invention; as shown in FIG. 1B, pluralities of dynamos 120 are suspended underwater by means of three-forces equilibrium, i.e. buoyant force F_{B}, water current force F_{C} and pulling force F_{P} of the fixing cable 111. Wherein the buoyant force F_{B} is the force exerted on the dynamos 120 by the water, and is upward always; the current force F_{C} is relevant to or proportional to the flow velocity, and has the same direction as the current direction; the pulling force F_{P} of the fixing cable 111 is the force utilized to balance the buoyant force F_{B} and the current force F_{C}, and has downward component of force always. As shown in FIG. 1B, the fixing cable 111 is connected to beneath of the dynamos 120, therefore the dynamos 120 are always balanced and kept stable without flipping over by means of buoyant F_{B}, current force F_{C} and pulling Force F_{P}, regardless of current velocity change, turbulence, reflux or backflow happened. If the water current changes, the angle θ between the fixing cable 111 and the seabed is automatically adjusted. Thus the current turbine system 110 of present invention may be kept stable without flipping over, and hence can be applied to any underwater condition.

### 2^{nd} and 3^{rd} Embodiment

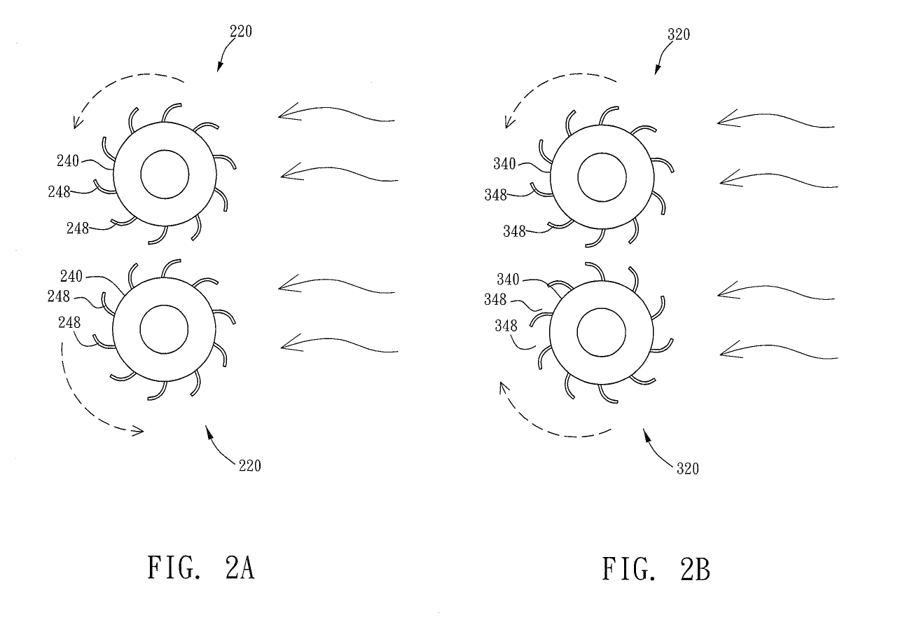

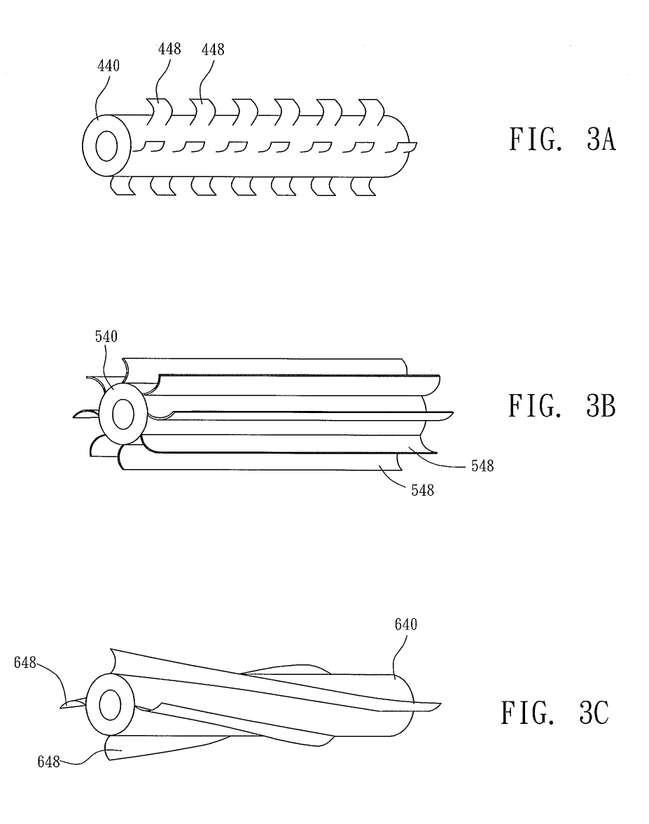

Please refer to FIG. 2A˜2B, FIG. 2A is diagram of rotor unit according to the 2^{nd} embodiment of present invention, FIG. 2B is diagram of rotor unit according to the 3^{rd} embodiment of present invention. As shown in FIG. 2A, the disturbing elements 248 of each dynamo 220 are protruded structures relative to the rotor unit 240. The upper dynamo 220 contains disturbing elements 248 with identical orientation comparative to the lower dynamo 220, i.e. the upper dynamo 220 has identical rotative vector comparative to the lower dynamo 220, therefore upper and lower rotor units 240 may rotate counterclockwise. As shown in FIG. 2B, the disturbing elements 348 of each dynamo 320 are also protruded structures relative to the rotor unit 340. However, the upper dynamo 320 contains disturbing elements 348 with different orientation comparative to the lower dynamo 320, i.e. the upper dynamo 320 has different rotative vector comparative to the lower dynamo 320, therefore upper rotor unit 340 may rotate counterclockwise, and lower rotor unit 340 may rotate clockwise. In preferable case, one current turbine system may have pluralities of rotor units wherein each rotative vector of the rotor units are different; so as to reduce or diminish the drawback resulted from resonance frequency. If the problems caused from resonance frequency are minor or unapparent, the disturbing elements of the rotor units might be disposed at the same orientation and the same rotative vector, so that manufacture or installation for the dynamos or the current turbine system is easier.

### 4^{th}, 5^{th}, and 6^{th} Embodiment

Please simultaneously refer to FIG. 3A˜3C, FIG. 3A is diagram of rotor unit according to the 4^{th} embodiment of present invention; FIG. 3B is diagram of rotor unit according to the 5^{th} embodiment of present invention; FIG. 3C is diagram of rotor unit according to the 6^{th} embodiment of present invention. As shown in FIG. 3A, the disturbing elements 448 which protrude at outer surface of the rotor unit 440 might be blades or fins. Axial length of each disturbing element 448 is much less than rotative axis length of the rotor unit 440. Besides, some disturbing elements 448 are arranged in a line parallel to the rotative axis of the rotor unit 440. Because that the rotor unit 440 is long-axis shaped, the axial length of the rotor unit 440 might be as elongated as possible and hence the disturbing elements 448 might also be disposed as more as possible. So that the area of disturbing elements 448 facing to the water current could be maximum, and thus the pushing force might also be increased as far as possible. As for the embodiment of FIG. 3B, the rotor unit 540 is also long-axis shaped. Each disturbing element 548 could be outward protruded fin for which the axial length of the disturbing element 548 has the same length as the rotative axis of the rotor unit 540. Each disturbing element 548 is extended at a direction parallel to the rotative axis. In the embodiment of FIG. 3C, the rotor unit 640 is also long-axis shaped. Each disturbing element 648 is screw thread typed. Additionally, the disturbing elements 648 or the outer wall of the rotor unit 640 could be light or less weight material such as plastic, acrylic, resin, rubber or polymer, so that total weight of the rotor unit 640 is less and therefore the rotor unit 640 is easier to be rotated.

### 7^{th} and 8^{th} Embodiment

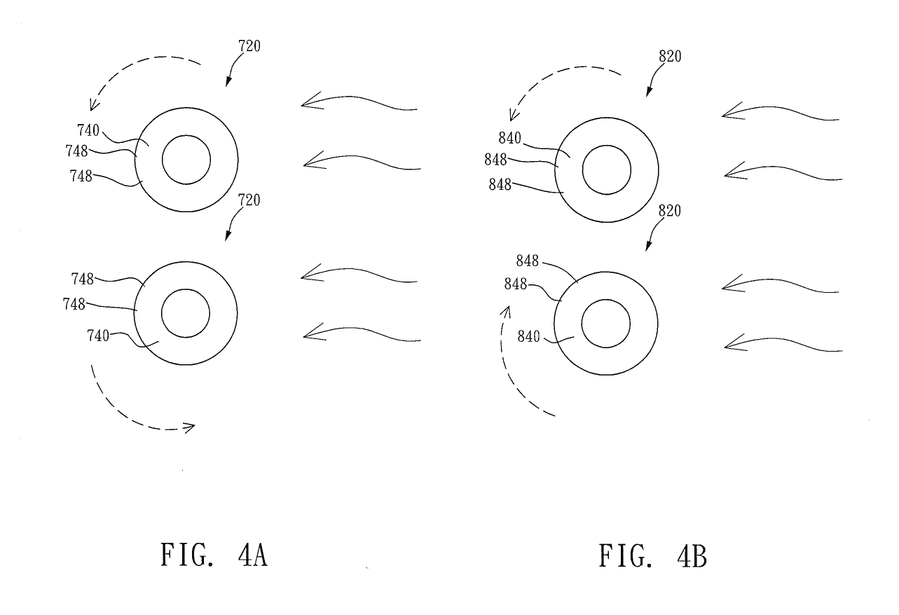

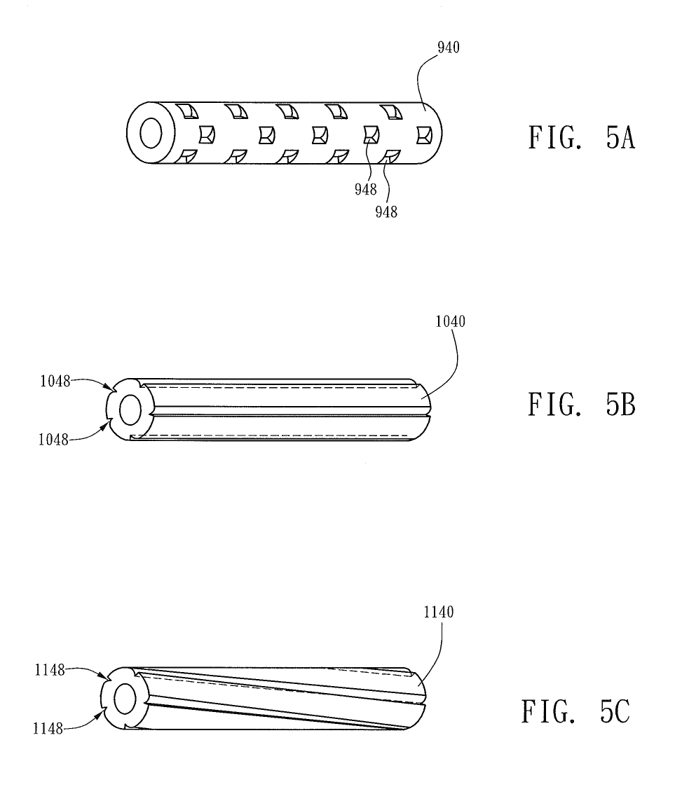

Please simultaneously refer to FIG. 4A˜4B, FIG. 4A is diagram of rotor unit according to the 7^{th} embodiment of present invention; FIG. 4B is diagram of rotor unit according to the 8^{th} embodiment of present invention. As shown in FIG. 4A, the disturbing elements 748 are concave structures which are recessed in the rotor unit 740. All disturbing elements 748 have identical orientation, thus each rotor unit 740 of respective dynamos 720 will rotate counterclockwise. As for the embodiment of FIG. 4B, the disturbing elements 848 are also concave structures which are recessed in the rotor units 840. However, the upper dynamo 820 contains disturbing elements 848 with different orientation comparative to the lower dynamo 820, i.e. the upper dynamo 820 has different rotative vector comparative to the lower dynamo 820, therefore upper rotor unit 840 may rotate counterclockwise, and lower rotor unit 840 may rotate clockwise.

### 9^{th}, 10^{th} and 11^{th} Embodiment

Please simultaneously refer to FIG. 5A˜5C, FIG. 5A is diagram of rotor unit according to the 9^{th} embodiment of present invention; FIG. 5B is diagram of rotor unit according to the 10^{th} embodiment of present invention; FIG. 5C is diagram of rotor unit according to the 11^{th} embodiment of present invention. As shown FIG. 5A, the rotor unit 940 is long-axis shaped. Axial length of each disturbing element 948 is much less than rotative axis length of the rotor unit 940. Besides, some disturbing elements 948 are arranged in a line parallel to the rotative axis of the rotor unit 940. As for the embodiment of FIG. 5B, the rotor unit 1040 is also long-axis shaped. Each disturbing element 1048 could be recessed structure for which the axial length of the disturbing element 1048 has the same length as the rotative axis of the rotor unit 1040. Each disturbing element 1048 is extended at a direction parallel to the rotative axis. As for the embodiment of FIG. 5C, the rotor unit 1140 is also long-axis shaped. Each disturbing element 1148 is screw thread typed.

Furthermore, outer face of the rotor unit or the disturbing element could further contains rough surface or pluralities of microstructures, so that the boundary layer (with respect to fluid mechanics) adjacent to those outer faces may be disturbed, and thus rotation of the rotor unit is smoother.

### 12^{th} Embodiment

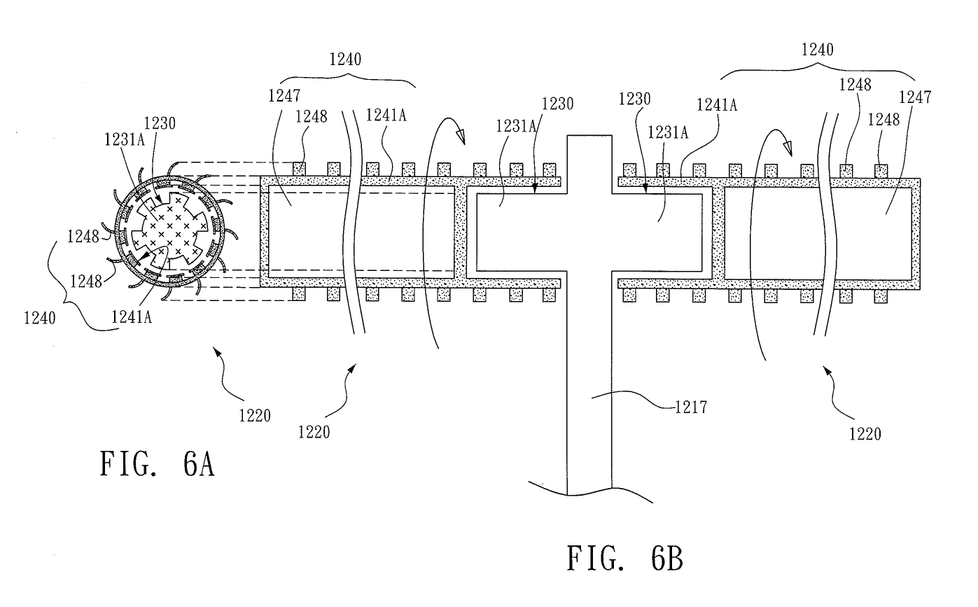

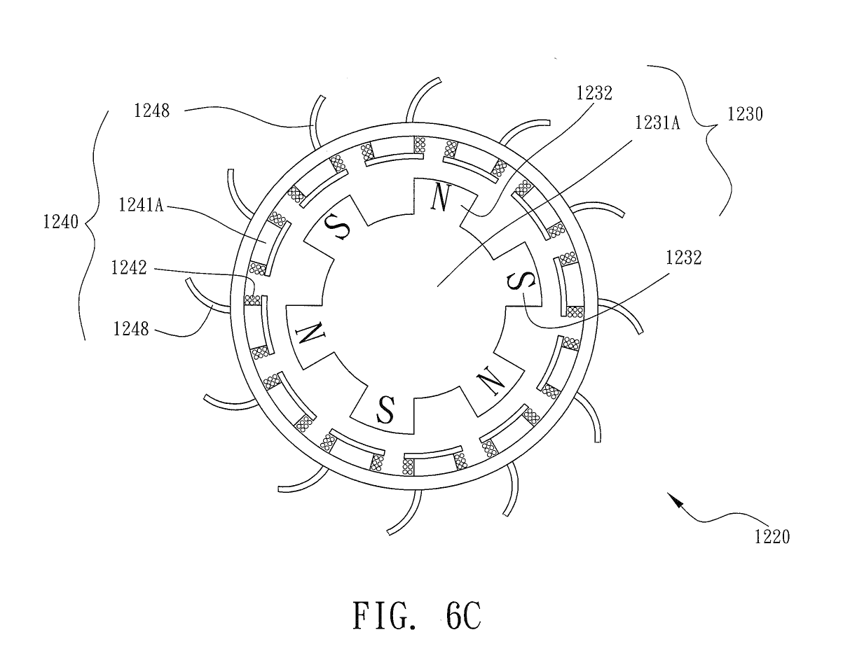

Next, the configuration of the current turbine system and the dynamo are introduced, so that the reason why dynamo floats above seabed is settled. Please simultaneously refer to FIG. 6A˜6C, FIG. 6A˜6C are diagrams of dynamo according to the 12^{th} embodiment of present invention. The dynamo 1220 is corresponding depicted to be sectional views in FIG. 6A and FIG. 6B. Two dynamos 1220 are respectively disposed at left side and right side of a holder 1217. Each dynamo 1220 contains a rotor unit 1240 and a stator unit 1230. The stator units 1230 are fixed or fastened to the holder 1217. The stator units 1230 not only support the dynamos 1220, but also conduct and then transfer the generated electricity outward. The rotor unit 1240 contains a sub-rotor 1241A; the sub-rotor 1241A may rotate along with the disturbing elements 1248 by means of pushing force driven by the water current. The stator unit 1230 contains a sub-stator 1231A. The sub-rotor 1241A and the sub-stator 1231A are concentrically disposed relative to rotative axis of the rotor unit 1240. Besides, the sub-stator 1231A is disposed at inside of the sub-rotor 1241A and adjacent to the sub-rotor 1241A. At interior of the rotor unit 1240, a space 1247 is sealed or encompassed inside, so that the space 1247 is isolated from exterior. As shown in FIG. 6B, if the axial length is longer, the volume of the space 1247 becomes larger, so that the average density of entire dynamo 1220 is therefore decreased and the buoyant force of the dynamo 1220 is increased. In this manner, the dynamo 1220 or the current turbine system may reduce average density by means of disposition of the space 1247. Namely, the buoyant force F_{B} of the dynamo 1220 or the current turbine system may be adjusted by means of changing the axial length of the space 1247 (i.e. changing the average density of the dynamo 1220 or average density of the current turbine system). When average density of the dynamo 1220 or average density of the current turbine system is less than water, the dynamo 1220 or the current turbine system may float. Besides, the rotative axis of the rotor unit 1240 is approximately perpendicular to the direction of water current, therefore longer rotative axis means more disturbing elements 1248 disposed and larger pushing force exerted on the rotor unit 1240; thus the friction between the rotor unit 1240 and the stator unit 1230 is easier to be overcome.

As shown in FIG. 6C, the sub-rotor 1241A includes pluralities of winding components 1242 inside. The sub-stator 1231A includes pluralities of magnetic components 1232 outside, in which each magnetic component 1232 could be composed of N poles and S poles. The sub-rotor 1241A surrounds the sub-stator 1231A. When the sub-rotor 1241A rotates around the sub-stator 1231A, the wires of the winding component 1242 may cross the lines of magnetic force neighboring the magnetic components 1232, so that electricity is hence generated. In preferable case, the iron core neighboring each winding component 1242 could be high permeability material such as silicon steel; the magnetic component 1232 could be permanent magnet so that the configuration of the stator unit 1230 or configuration of the rotor unit 1240 is simple or non-complex. Still, the magnetic component 1232 might also be excitation winding.

Moreover, the dynamo could further contain a solid substance or liquid substance disposed inside, wherein the solid substance or the liquid substance (e.g. dry ice, naphthalene, camphor, ether, formaldehyde, etc.) is able to slowly evaporate gas. The disposition location of the solid substance or liquid substance could be the space 1247 or the gap between the rotor unit 1240 and the stator unit 1230. The fixing means for the solid substance or the liquid substance could be fastening, supporting or container receiving. In this manner, the solid substance or the liquid substance may slowly evaporate gas, then the gas fills the space 1247 (or the aforesaid gap) so that the pressure inside the dynamo 1220 may be kept at relatively higher standard. Therefore the water or vapor is prevent from entering the dynamo 1220, and thus all components inside the dynamo 1220 will have little chance to erode or become rusty; the dynamo 1220 may absolutely have longer operating life.

### 13^{th} Embodiment

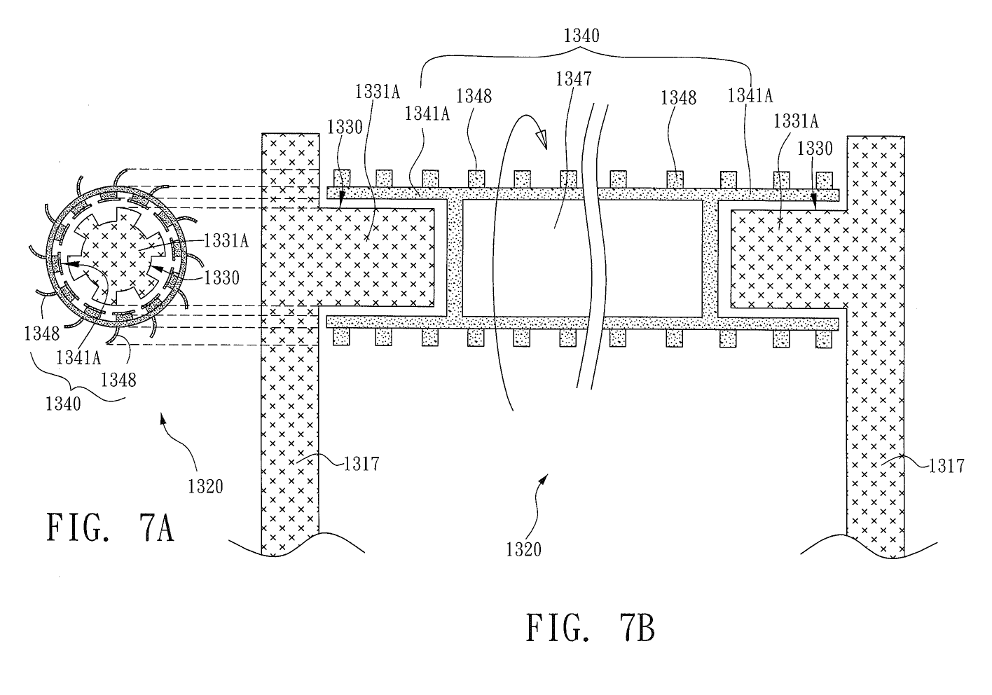

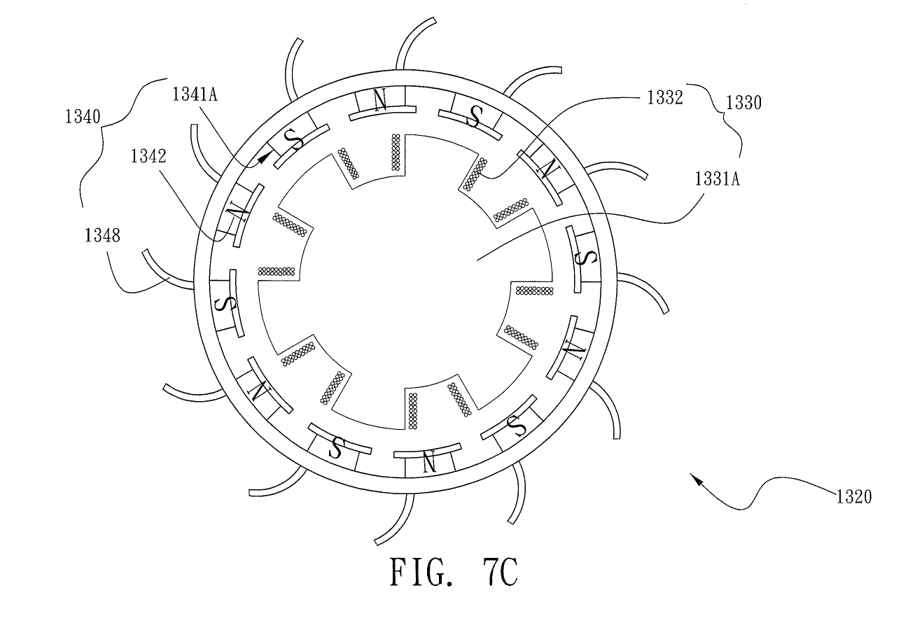

Please simultaneously refer to FIG. 7A˜7C, FIG. 7A˜7C are diagrams of dynamo according to the 13^{th} embodiment of present invention; The dynamo 1320 is corresponding depicted to be sectional views in FIG. 7A and FIG. 7B. As shown in FIG. 7A and FIG. 7B, a dynamo 1320 is disposed between two holders 1317. The dynamo 1320 contains a rotor unit 1340, two stator units 1330 and a space 1347. Two stator units 1330 are respectively disposed at left side and right side of the dynamo 1320. Each of two stator unit 1330 is connected to a holder 1317, so as to fix the dynamo 1320. The rotor unit 1340 includes two sub-rotors 1341A disposed at left side and right side. The sub-rotors 1341A may rotate along with the disturbing elements 1348 by means of pushing force driven by the water current. The space 1347 is disposed between two ends of the rotor unit 1340; namely, two stator units 1330 are disposed at two axial ends of the space 1347, and are adjacent to the space 1347. Each stator unit 1330 further includes a sub-stator 1331A. Each sub-rotor 1341A is corresponded to a sub-stator 1331A. The sub-stator 1331A is disposed at inside of the sub-rotor 1341A and adjacent to the sub-rotor 1341A. The sub-rotor 1341A and the sub-stator 1331A are concentrically disposed relative to rotative axis of the rotor unit 1340. The electricity generated between the sub-rotor 1341A and the sub-stator 1331A in left side of the dynamo 1320 may be conduct outward by means of the holder 1317 in the left; similarly, the electricity generated between the sub-rotor 1341A and the sub-stator 1331A in right side of the dynamo 1320 may be conduct outward by means of the holder 1317 in the right.

As shown in FIG. 7C, the sub-rotor 1341A might include pluralities of magnetic components 1342, in which each magnetic component 1342 could be composed of N poles and S poles. The direction of the N pole or S pole could orient inward (i.e. orienting to center). The sub-stator 1331A includes pluralities of winding components 1332. The sub-rotor 1341A surrounds the sub-stator 1331A. When the sub-rotor 1341A rotates around the sub-stator 1331A, the wires of the winding component 1332 may cross the lines of magnetic force neighboring the magnetic components 1342, so that electricity is hence generated. In practice, the magnetic components 1342 of the sub-rotor 1341A could be permanent magnet or exciting magnet.

### 14^{th} Embodiment

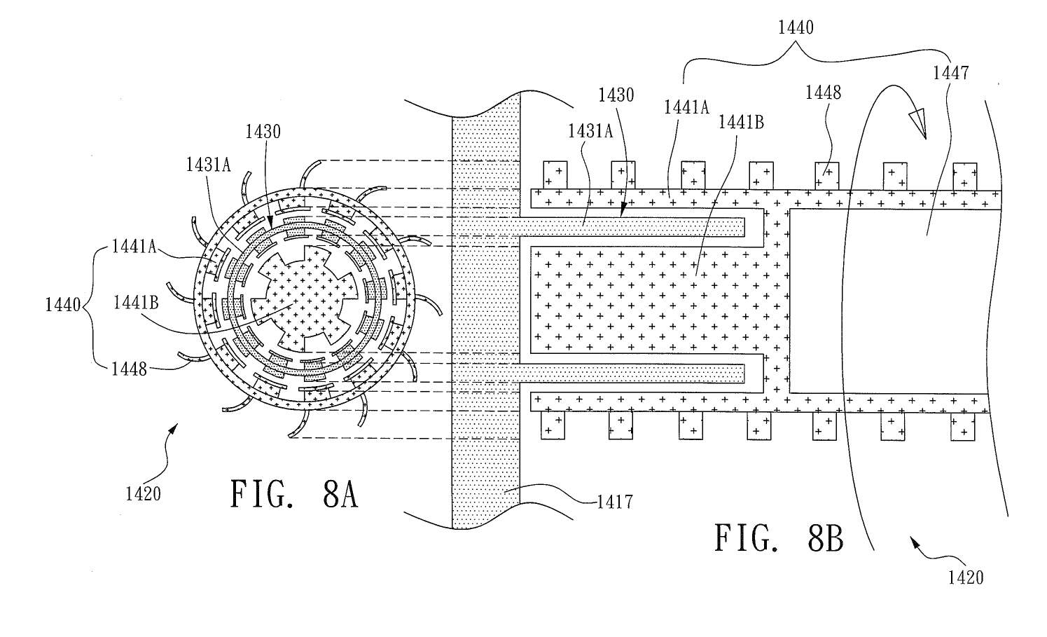

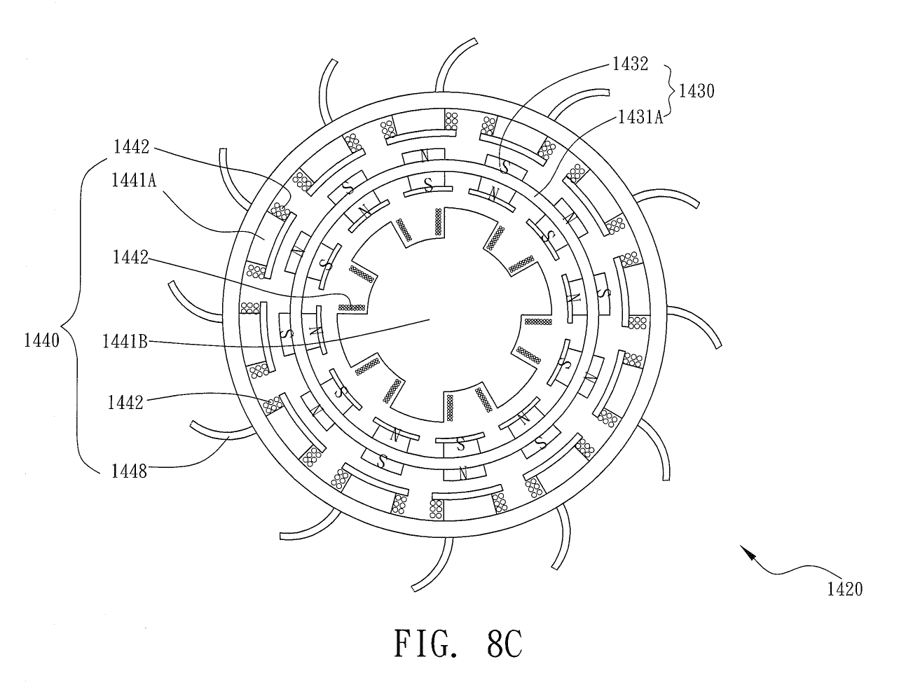

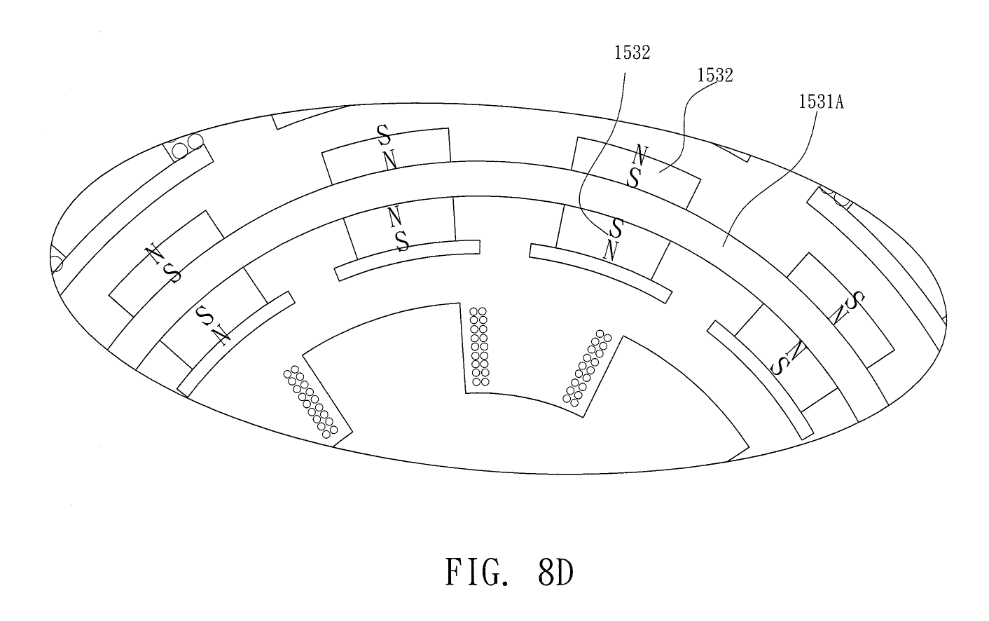

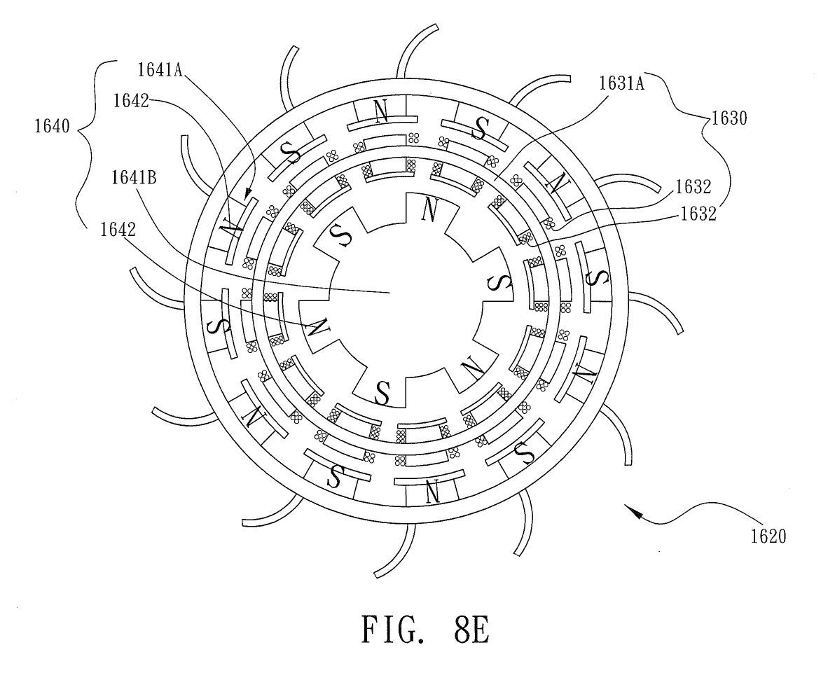

Please simultaneously refer to FIG. 8A˜8C, FIG. 8A˜8C are diagrams of dynamo according to the 14^{th} embodiment of present invention; the dynamo 1420 is corresponding depicted to be sectional views in FIG. 8A and FIG. 8B. As shown in FIG. 8A and FIG. 8B, a dynamo 1420 is disposed at right side of the holder 1417. The dynamo 1420 contains a rotor unit 1440, a stator unit 1430 and a space 1447. The rotor unit 1440 includes a sub-rotor 1441A and a sub-rotor 1441B. The stator unit 1430 includes a sub-stator 1431A. The sub-rotor 1441A and the sub-rotor 1441B may rotate along with the disturbing elements 1448 of the rotor unit 1440 by means of pushing force driven by the water current. The sub-stator 1431A is concentrically disposed between the sub-rotor 1441A and sub-rotor 1441B; therefore the sub-rotor 1441A is disposed at outside of the sub-stator 1431A and then adjacent to the sub-stator 1431A; the sub-rotor 1441B is disposed at inside of the sub-stator 1431A and then adjacent to the sub-stator 1431A. In this manner, the sub-rotor 1441A, the sub-stator 1431A and the sub-rotor 1441B are alternately disposed (i.e. orderly disposition).

As shown in FIG. 8C, the sub-rotor 1441A or the sub-rotor 1441B could include pluralities of winding components 1442. The sub-stator 1431A might include pluralities of magnetic components 1432, in which each magnetic component 1432 could be composed of N poles and S poles. As shown in FIG. 8C, the magnetic components 1432 disposed at inside or outside of the sub-stator 1431A could be one magnet or two magnets with identical pole orientation. Moreover, the magnetic components 1432 having N pole oriented outward and the magnetic components 1432 having N pole oriented inward are alternately arranged at circumference of the sub-stator 1431A. When the rotor unit 1440 rotates, the winding components 1442 of the sub-rotor 1441A may cross the lines of magnetic force at outside of the sub-stator 1431A; the winding components 1442 of the sub-rotor 1441B may cross the lines of magnetic force at inside of the sub-stator 1431A.

### 15^{th} Embodiment

Please refer to FIG. 8D, FIG. 8D is diagram of dynamo according to the 15^{th} embodiment of present invention; the configuration of the dynamo in FIG. 8D is similar to FIG. 8C, so no need to further address. In the embodiment of FIG. 8D, the sub-stator 1531A includes pluralities of magnetic components 1532 disposed at inside and outside; however, every two corresponding magnetic components 1532 have opposite orientation.

### 16^{th} Embodiment

Please refer to FIG. 8E, FIG. 8E is diagram of dynamo according to the 16^{th} embodiment of present invention; as shown FIG. 8E, the rotor unit 1640 of the dynamo 1620 contains a sub-rotor 1641A and a sub-rotor 1641B. The stator unit 1630 contains a sub-stator 1631A. The rotor unit 1640 and the stator unit 1630 have similar configurations to the embodiment of FIG. 8C. The sub-rotor 1641A and the sub-rotor 1641B both include pluralities of magnetic components 1642, in which the magnetic components 1642 could be composed of N poles and S poles. In preferable embodiment, the N poles and S poles are alternately arranged at circumference of the sub-rotor 1641A and arranged at circumference of the sub-rotor 1641B. In other embodiment, the magnetism, disposition location or pole orientation of the N poles and S poles might also be changed; even the middle pole could be formed as well. The sub-stator 1631A includes pluralities of winding components 1632 outside, wherein the winding components 1632 disposed outside near the sub-rotor 1641A; also, the sub-stator 1631A includes pluralities of winding components 1632 inside, wherein the winding components 1632 disposed inside near the sub-rotor 1641B. In this manner, when the rotor unit 1640 rotates, the winding components 1632 at inside and outside of the sub-stator 1631A may cross the lines of magnetic force, in which the lines of magnetic force near the magnetic components 1642 and surround the sub-rotor 1641A and sub-rotor 1641B.

### 17^{th} Embodiment

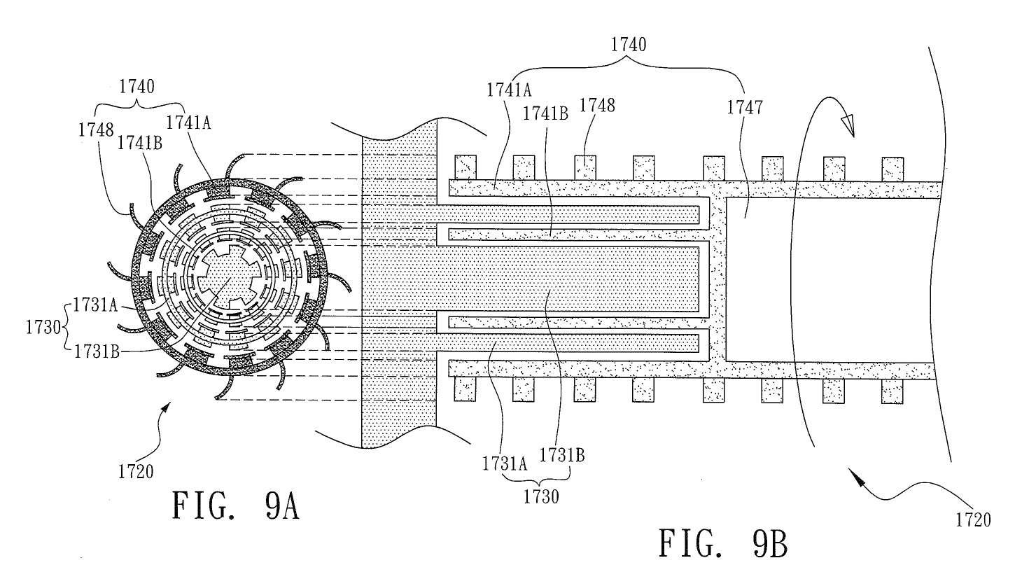

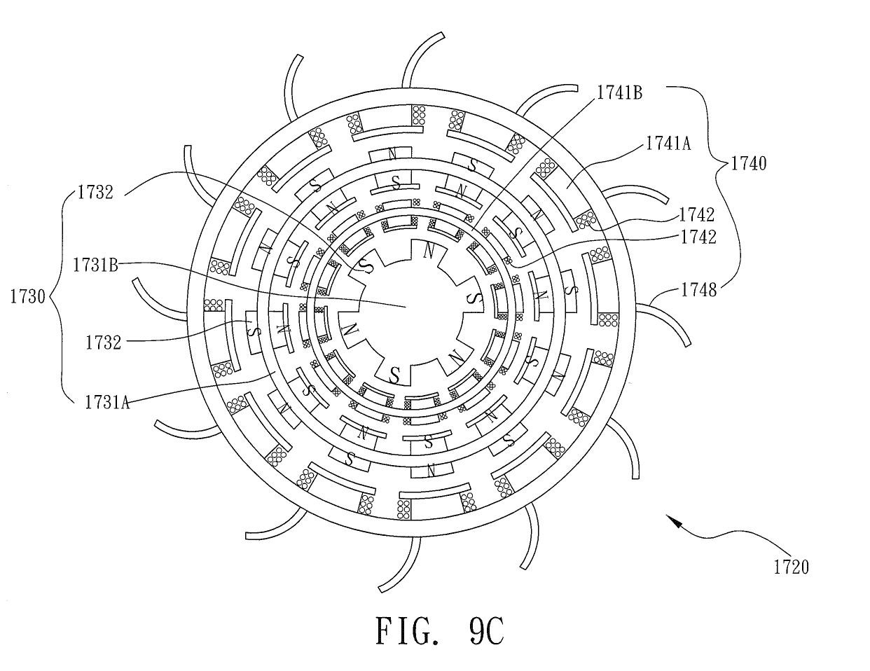

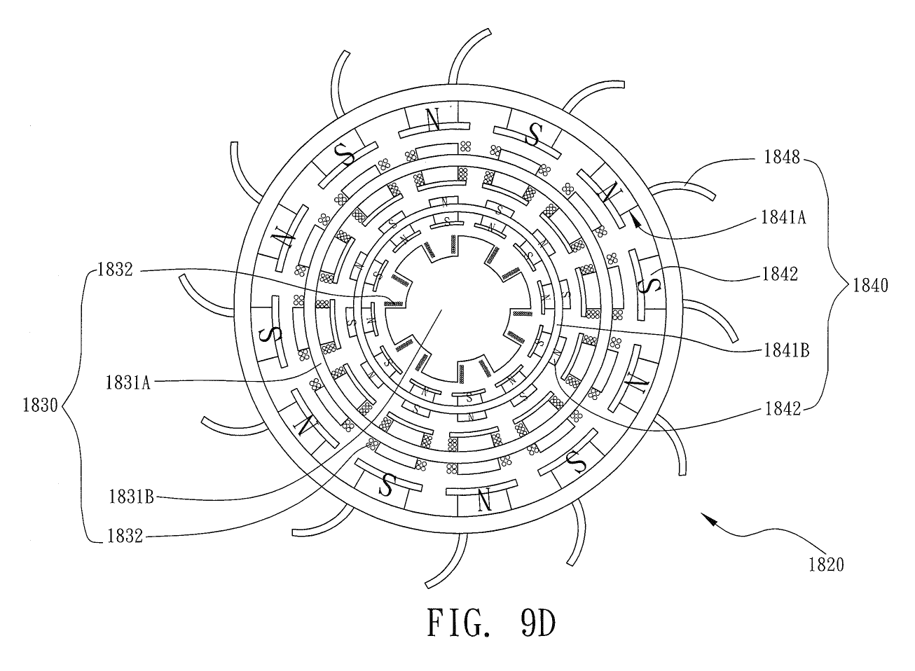

Please simultaneously refer to FIG. 9A˜9C, FIG. 9A˜9C are diagrams of dynamo according to the 17^{th} embodiment of present invention; the dynamo 1720 is corresponding depicted to be sectional views in FIG. 9A and FIG. 9B. As shown in FIG. 9A and FIG. 9B, the dynamo 1720 contains a rotor unit 1740, a stator unit 1730 and a space 1747. The rotor unit 1740 contains a sub-rotor 1741A and a sub-rotor 1741B. The stator unit 1730 contains a sub-stator 1731A and a sub-stator 1731B. The sub-rotor 1741A and the sub-rotor 1741B may rotate along with the disturbing elements 1748 of the rotor unit 1740 by means of pushing force driven by the water current. The sub-rotor 1741A, the sub-stator 1731A, the sub-rotor 1741B and the sub-stator 1731B are concentrically disposed from outside to inside. In this manner, the sub-rotor 1741A and the sub-rotor 1741B are respectively disposed at and neighboring to the outside and inside of the sub-stator 1731A. Similarly, the sub-stator 1731A and the sub-stator 1731B are respectively disposed at and neighboring to the outside and inside of the sub-rotor 1741B.

As shown in FIG. 9C, the sub-rotor 1741A and the sub-rotor both 1741B include pluralities of winding components 1742. The sub-stator 1731A and the sub-stator 1731B both include pluralities of magnetic components 1732. Besides, the magnetism, disposition location or pole orientation of the N poles and S poles of the magnetic components 1732 might also be changed.

### 18^{th} Embodiment

Please refer to FIG. 9D, FIG. 9D is diagram of dynamo according to the 18^{th} embodiment of present invention; as shown in FIG. 9D, the rotor unit 1840 of the dynamo 1820 contains a sub-rotor 1841A and a sub-rotor 1841B. The stator unit 1830 contains a sub-stator 1831A and a sub-stator 1831B. The rotor unit 1840 and the stator unit 1830 have similar configurations to the embodiment of FIG. 9C. In this embodiment, the sub-rotor 1841A and the sub-rotor 1841B both include pluralities of magnetic components 1842; the N poles and S poles of magnetic components 1842 are alternately arranged at circumference of the sub-rotor 1841A and at circumference of the sub-rotor 1841B. The sub-stator 1831A includes pluralities of winding components 1832 outside, wherein the winding components 1832 disposed outside near the sub-rotor 1841A; also, the sub-stator 1831A includes pluralities of winding components 1832 inside, wherein the winding components 1832 disposed inside near the sub-rotor 1841B; still, the sub-stator 1831B includes pluralities of winding components 1832 outside, wherein the winding components 1832 disposed outside near the sub-rotor 1841B.

### 19^{th} Embodiment

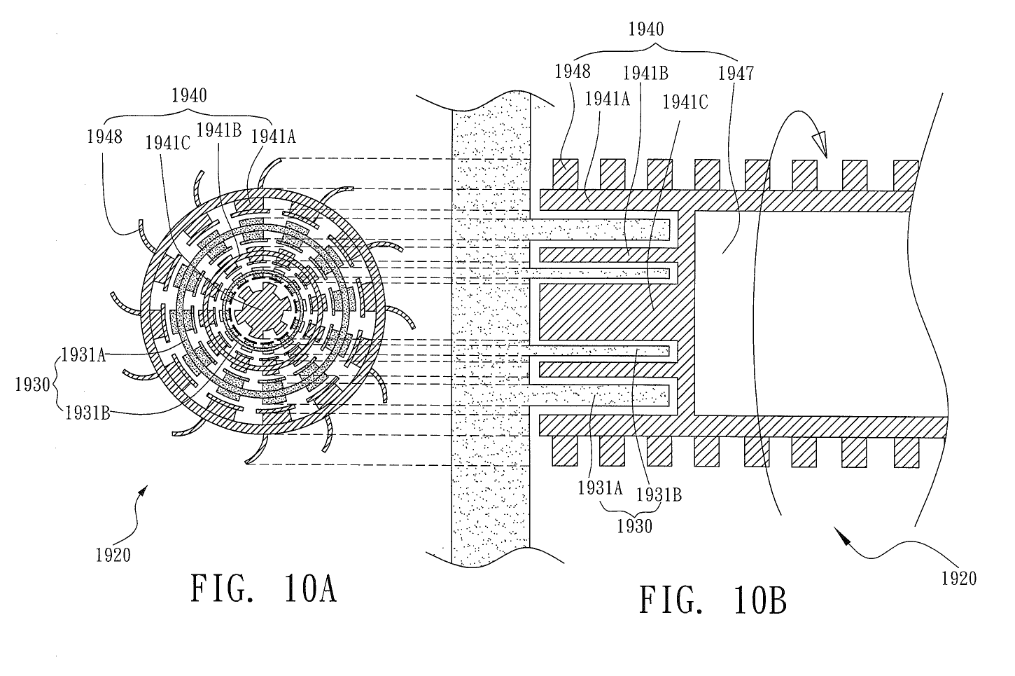

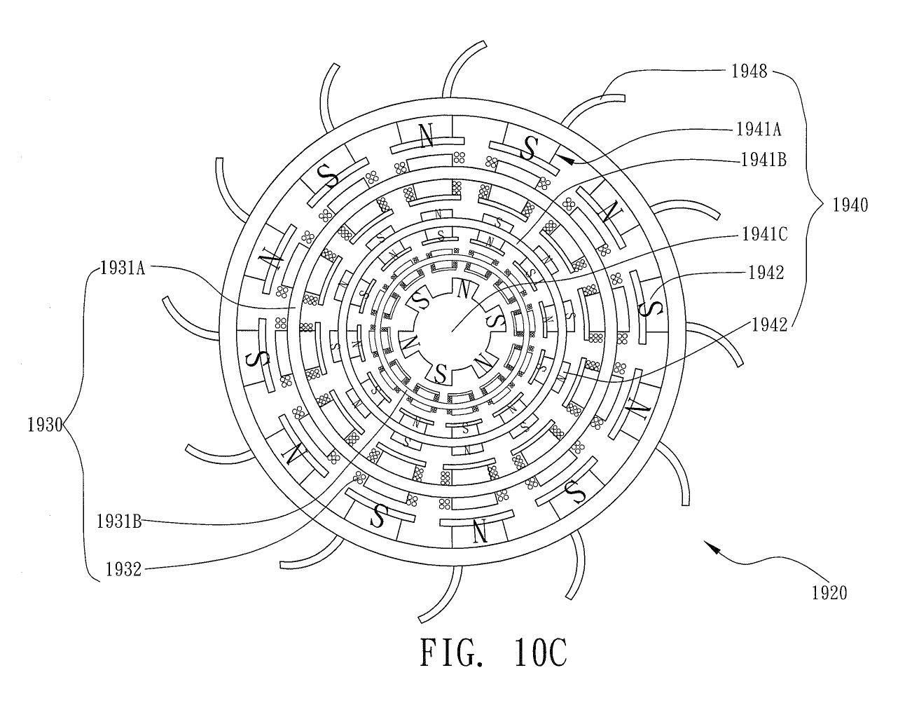

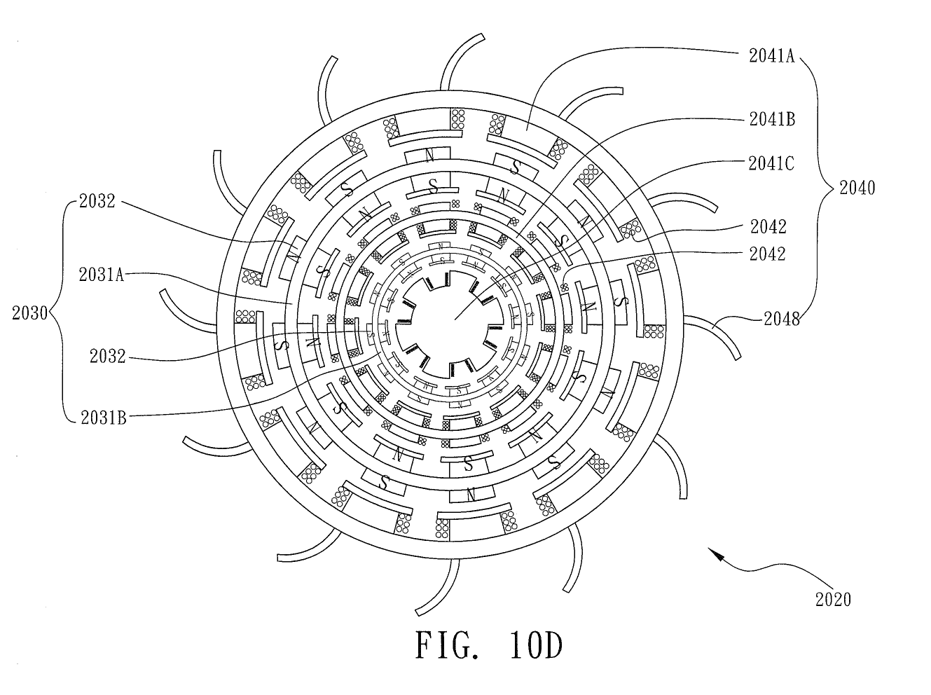

Please simultaneously refer to FIG. 10A˜10C, FIG. 10A˜10C are diagrams of dynamo according to the 19^{th} embodiment of present invention; the dynamo 1920 is corresponding depicted to be sectional views in FIG. 10A and FIG. 10B. As shown in FIG. 10A and FIG. 10B, the dynamo 1920 contains a rotor unit 1940, a stator unit 1930 and a space 1947. The rotor unit 1940 contains a sub-rotor 1941A, a sub-rotor 1941B and a sub-rotor 1941C. The stator unit 1930 contains a sub-stator 1931A and a sub-stator 1931B. The sub-rotor 1941A, the sub-rotor 1941B and the sub-rotor 1941C may rotate along with the disturbing elements 1948 of the rotor unit 1940 by means of pushing force driven by the water current. The sub-rotor 1941A, the sub-stator 1931A, the sub-rotor 1941B, the sub-stator 1931B and the sub-rotor 1941C are concentrically disposed from outside to inside. In this manner, the sub-rotor 1941A and the sub-rotor 1941B are respectively disposed at and neighboring to the outside and inside of the sub-stator 1931A. Similarly, the sub-stator 1931A and the sub-stator 1931B are respectively disposed at and neighboring to the outside and inside of the sub-rotor 1941B. Also, the sub-rotor 1941B and the sub-rotor 1941C are respectively disposed at and neighboring to the outside and inside of the sub-stator 1931B.

As shown in FIG. 10C, the sub-rotor 1941A, the sub-rotor 1941B and the sub-rotor 1941C include pluralities of magnetic components 1942. The magnetic components 1942 of the sub-rotor 1941A are disposed at inside of the sub-rotor 1941A; the magnetic components 1942 of the sub-rotor 1941B are disposed at inside and outside of the sub-rotor 1941B; the magnetic components 1942 of the sub-rotor 1941C are disposed at outside of the sub-rotor 1941C. The sub-stator 1931A and the sub-stator 1931B both include pluralities of winding components 1932.

### 20^{th} Embodiment

Please refer to FIG. 10D, FIG. 10D is diagram of dynamo according to the 20^{th} embodiment of present invention; as shown in FIG. 10D, the rotor unit 2040 of the dynamo 2020 contains a sub-rotor 2041A, a sub-rotor 2041B and a sub-rotor 2041C. The stator unit 2030 contains a sub-stator 2031A and a sub-stator 2031B. The rotor unit 2040 and the stator unit 2030 have similar configurations to the embodiment of FIG. 10C. In this embodiment, the sub-rotor 2041A, the sub-rotor 2041B and the sub-rotor 2041C include pluralities of winding component 2042. The sub-stator 2031A and the sub-stator 2031B both include pluralities of magnetic components 2032. The N poles and S poles of magnetic components 2032 are alternately arranged at circumference of the sub-stator 2031A and at circumference of the sub-stator 2031B.

Summarily, in the 12^{th} embodiment as shown in FIG. 6A˜6C, the number of the corresponding sub-rotor and sub-stator are 1; in the 13^{th} embodiment as shown in FIG. 7A˜7C, the number of the corresponding 15^{th} sub-rotor and sub-stator are 1; in the 14^{th}, 15¹ and 16^{th} embodiment as shown in FIG. 8A˜8E, the number of the sub-rotor is 2 and the number of the corresponding sub-stator is 1; in the 17^{th} and 18^{th} embodiment as shown in FIG. 9A˜9D, the number of the sub-rotor is 2 and the number of the corresponding sub-stator is also 2; in the 19^{th} and 20^{th} embodiment as shown in FIG. 10A˜10D, the number of the sub-rotor is 3 and the number of the corresponding sub-stator is 2. As a result, a simple formula can be concluded from 12^{th}˜20^{th} embodiments: the number of sub-rotor inside a rotor unit is m; the number of the corresponding sub-stator inside a stator unit is n; and then the equation of m=n or m=n+1 are satisfied. In this manner, the number of sub-rotor and the corresponding sub-stator may be as more as possible by taking advantages of concentrically disposition and larger diameter of the entire dynamo. Additionally, if the number of the sub-rotor or the number of the sub-stator is more than or equal to 2, the sub-rotor and the sub-stator are alternately disposed, so that the winding component and the magnetic component also can be disposed as more as possible. Therefore the generated electricity of the dynamo is maximized.

### 21^{st} Embodiment

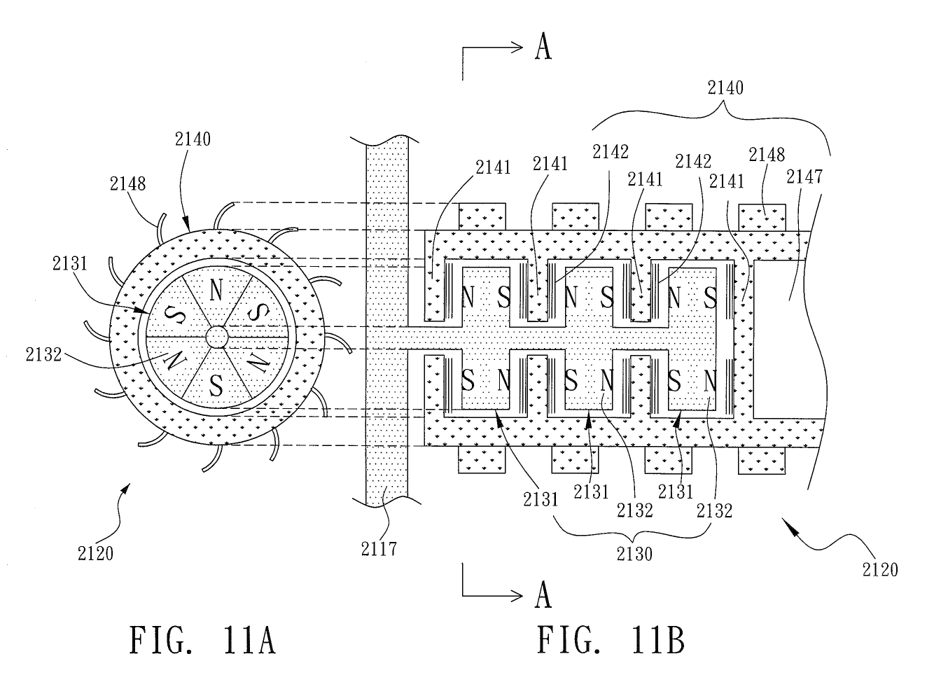

As aforesaid description, the arrangement of the sub-rotor and sub-stator is concentrically disposed, thus all of sub-rotors and sub-stators have different diameters. However, the sub-rotor and sub-stator may also be disposed at different axial sites of the dynamo. Please simultaneously refer to FIG. 11A˜11B, FIG. 11A is A-A sectional diagram of FIG. 11B; FIG. 11B is diagram of dynamo according to the 21^{st} embodiment of present invention. In these diagrams, the dynamo 2120 is corresponding depicted to be sectional views in FIG. 11A and FIG. 11B. As shown in FIG. 11A and FIG. 11B, the dynamo 2120 is fixed at right side of the holder 2117 by means of a stator unit 2130; the dynamo 2120 further contains a rotor unit 2140 and a space 2147. The rotor unit 2140 includes four sub-rotors 2141; the sub-rotors 2141 are axially disposed relative to the rotative axis of the rotor unit 2140. Besides, the sub-rotors 2141 may rotate along with the disturbing elements 2148 of the rotor unit 2140. The stator unit 2130 includes three sub-stators 2131, in which the sub-stators 2131 are also disposed at axial direction. Specifically, the sub-rotors 2141 and the sub-stators 2131 are alternately disposed at axial direction of the dynamo 2120, so that each sub-rotor 2141 is adjacent to at least one sub-stator 2131, and each sub-stator 2131 is adjacent to at least one sub-rotor 2141.

Each sub-stator 2131A includes pluralities of magnetic components 2132. Each sub-rotor 2141 includes pluralities of winding components 2142. In this manner, each winding component 2142 is adjacent to at least one magnetic component 2132; each magnetic component 2132 is adjacent to at least one winding component 2142. The magnetic component 2132 could be permanent magnet or excitation winding magnet; moreover, the magnetism, disposition location or pole orientation of the magnetic component 2132 might also be changed; even the middle pole could be formed as well. Practically, as shown FIG. 11B, the sub-rotor 2141 in the leftmost has winding component 2142 disposed at its right side; the sub-rotor 2141 in the rightmost has winding component 2142 disposed at its left side; the other sub-rotors 2141 in the middle have winding components 2142 disposed at their left side and right side. In this manner, the dynamo 2120 may contain the sub-rotors 2141 and the sub-stators 2131 as more as possible, so as to maximize the generated electricity.

As shown in FIG. 11A, the sub-stator 2131 is disposed at inside of the dynamo 2120; the N poles and S poles of the magnetic component 2132 are alternately disposed at different argument (i.e. different azimuth angle based upon the rotative axis).

### 22^{nd} Embodiment

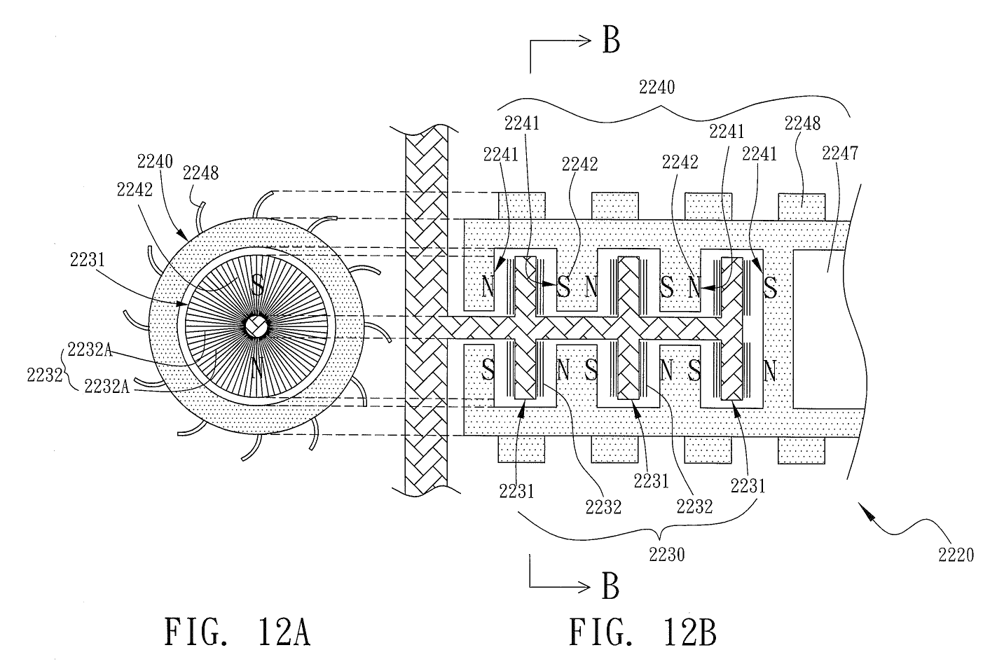

Please simultaneously refer to FIG. 12A˜12B, FIG. 12A is B-B sectional diagram of FIG. 12B; FIG. 12B is diagram of dynamo according to the 22^{nd} embodiment of present invention; in these diagrams, the dynamo 2220 is corresponding depicted to be sectional views in FIG. 12A and FIG. 12B. As shown in FIG. 12A and FIG. 12B, the dynamo 2220 contains a rotor unit 2240, a stator unit 2230 and a space 2247. The rotor unit 2240 contains four sub-rotors 2241; the stator unit 2230 contains three sub-stators 2231; wherein the sub-rotors 2241 and the sub-stators 2231 have similar configuration to the embodiment of FIG. 11A. In this embodiment, the sub-rotors 2241 include pluralities of magnetic components 2242; the sub-stators 2231 include winding components 2232 disposed at left side and right side. Therefore, each winding component 2232 is adjacent to at least one magnetic component 2242, and each magnetic component 2242 is adjacent to at least one winding component 2232.

As shown in FIG. 12A, the winding components 2232 of the sub-stator 2231 are composed of pluralities of wires 2232A radial winded on the sub-stator 2231. When the magnetic component 2242 rotates along with the rotor unit 2240, the wires 2232A may cross the lines of magnetic force, in which the lines of magnetic force near the magnetic components 2242.

### 23^{rd} Embodiment

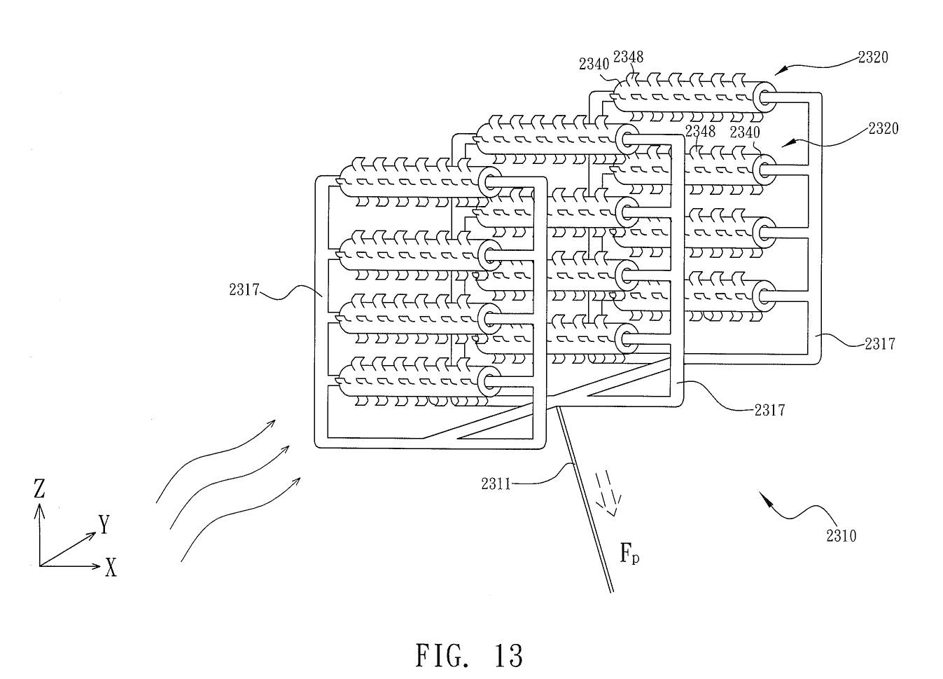

Next, the current turbine system having pluralities of dynamos is introduced. Please refer to FIG. 13, FIG. 13 is diagram of dynamos according to the 23^{rd} embodiment of present invention. As shown in FIG. 13, the current turbine system 2310 comprises 12 dynamos 2320. The dynamos 2320 are disposed at the current turbine system 2310 by means of fixing the stator units (not marked, at two ends of dynamo 2320) to the holder 2317. Every four dynamos 2320 are grouped together. Three groups of dynamos 2320 could be disposed at different altitude or arranged with different elevation angle or different azimuth angle; the dynamos 2320 at different groups could be stagger or zigzag arranged (i.e. not arranged in a line). In this manner, the drawback of fluidic wake generated from the upstream dynamo 2320 could be prevented, and thus the void turbulence which reduces the current force F_{C} may be diminished. The fixing cable 2311 is disposed at beneath of the holder 2317, and is connected to the stator unit by means of the holder 2317. The lower end of the fixing cable 2311 connects to the bottom of the water, so that the electricity generated from the dynamos 2320 may be conducted or transferred outward; besides, the fixing cable 2311 may also have function of suspending those dynamos 2320 by means of the pulling force F_{P}. Moreover, the rotative axis of the rotor unit 2340 could be approximately perpendicular to the water current. The disturbing elements 2348 of different dynamos 2320 might have different orientation, so that the rotative vectors of those different dynamos 2320 are also different. If so, some rotor units 2340 may rotate clockwise and some other rotor units 2340 may rotate counterclockwise, and therefore the problem of resonance frequency is reduced.

### 24^{th} Embodiment

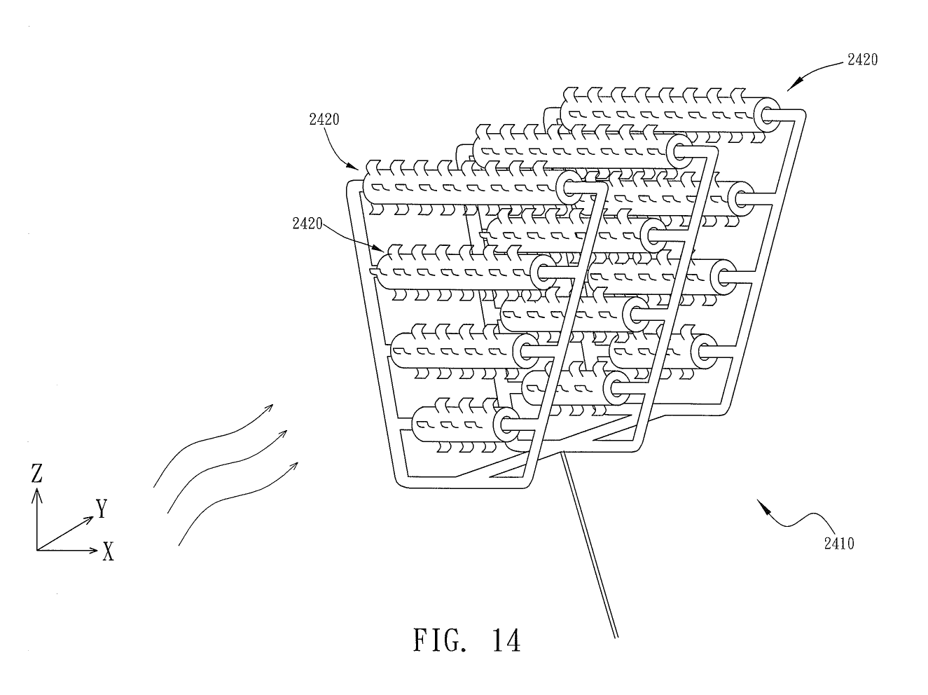

Please refer to FIG. 14, FIG. 14 is diagram of dynamos according to the 24^{th} embodiment of present invention; as shown in FIG. 14, the current turbine system 2410 comprises 12 dynamos 2420. Axis length of the lower dynamo 2420 is less than axis length of the upper dynamo 2420. Namely, the lower dynamo 2420 contains smaller volume of space disposed inside than the upper dynamo 2420. Therefore, the upper dynamo 2420 has larger buoyant force than the lower dynamo 2420.

### 25^{th} Embodiment

Please refer to FIG. 15, FIG. 15 is diagram of dynamos according to the 25^{th} embodiment of present invention; as shown in FIG. 15, the current turbine system 2510 comprises 12 dynamos 2520. Every four dynamos 2520 are grouped and horizontally disposed. The lower dynamo 2520 has smaller axis length than the upper dynamo 2520. The current turbine system 2510 is connected to bottom of water (could be seabed) by means of two fixing cables 2511.

### 26^{th} Embodiment

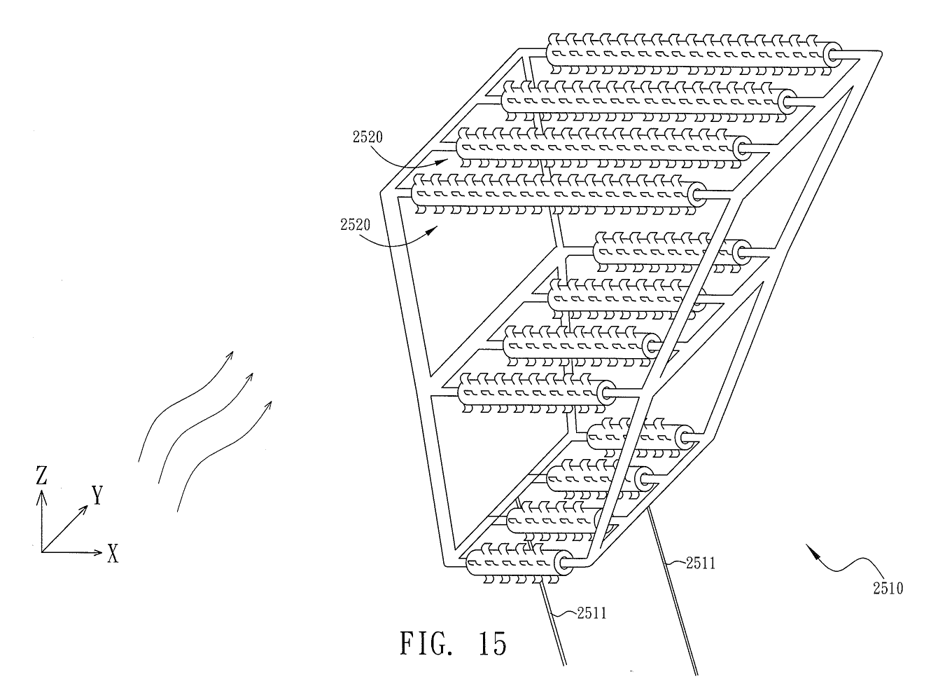

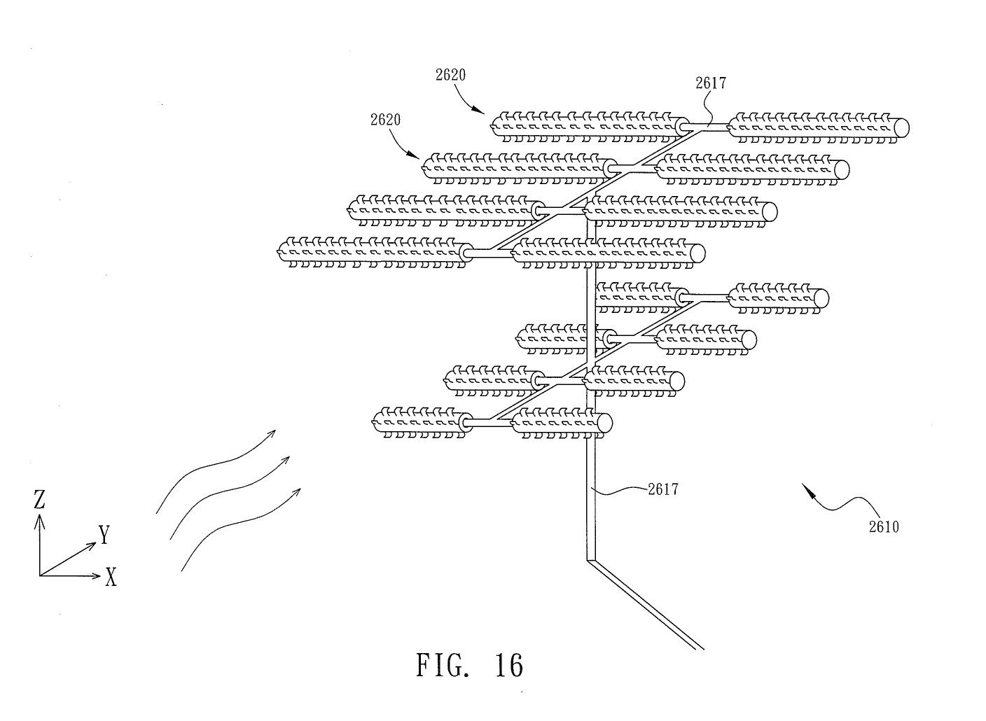

Please refer to FIG. 16, FIG. 16 is diagram of dynamos according to the 26^{th} embodiment of present invention; as shown in FIG. 16, the current turbine system 2610 comprises 16 dynamos 2620. Each dynamo 2620 contains a stator unit (not marked) disposed at one end of the dynamo 2620. The current turbine system 2610 fixes those dynamos 2620 by means of connecting the holder 2617 and the stator units. Every eight dynamos 2620 are grouped and horizontally disposed.

### 27^{th} Embodiment

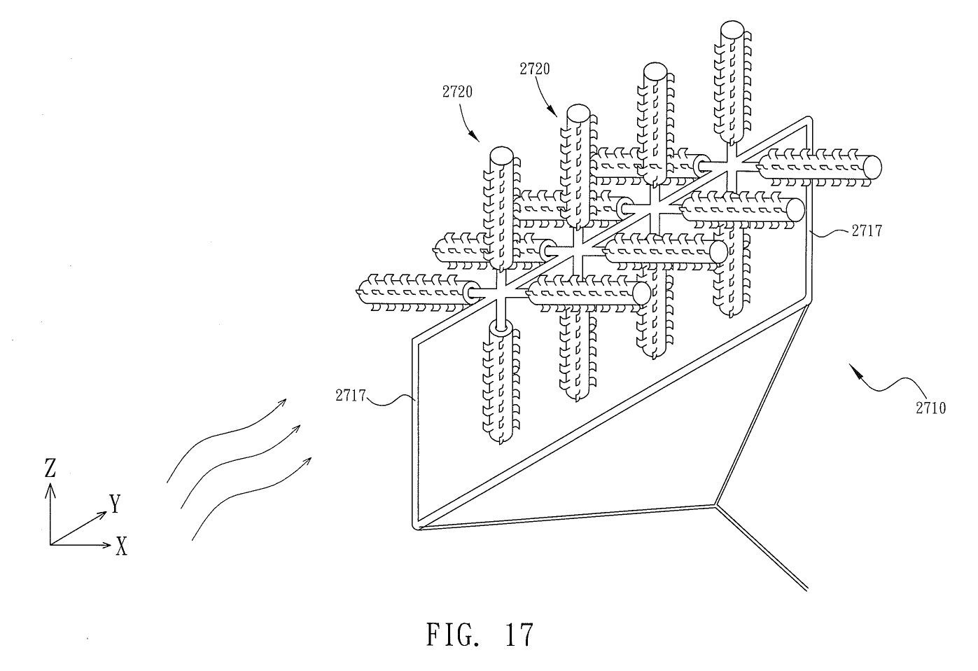

Please refer to FIG. 17, FIG. 17 is diagram of dynamos according to the 27^{th} embodiment of present invention; as shown in FIG. 17, the current turbine system 2710 comprises 16 dynamos 2720. Every four dynamos 2720 are grouped to be cross-shaped; the cross configuration could be perpendicular to the water current. Besides, all of dynamos 2720 are fixed by means of the holder 2717.

### 28^{th} Embodiment

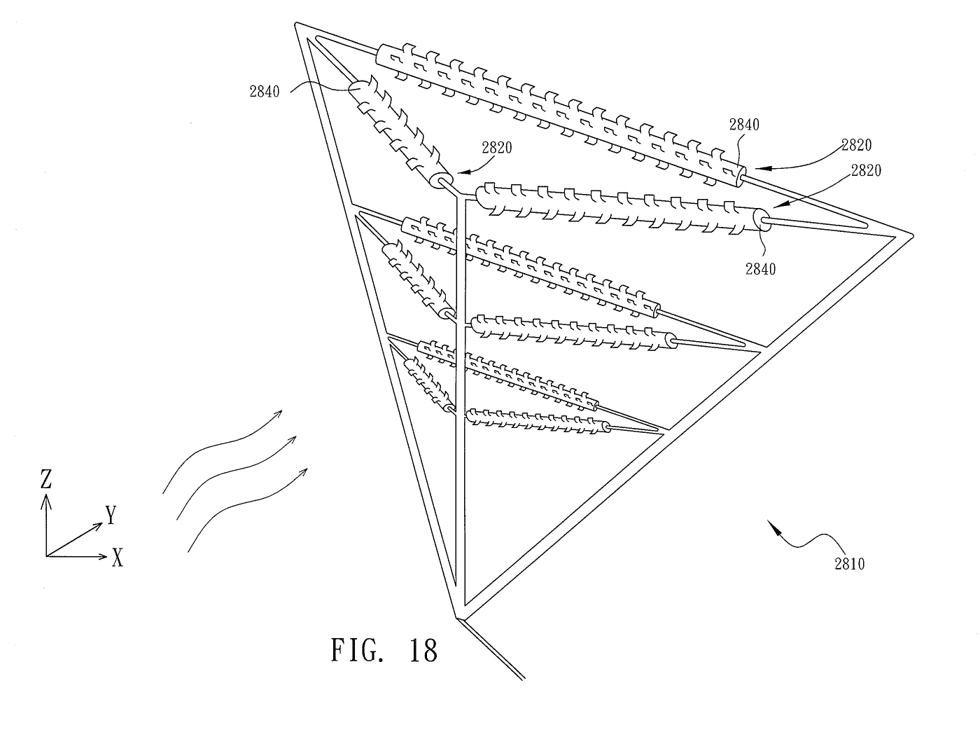

Please refer to FIG. 18, FIG. 18 is diagram of dynamos according to the 28^{th} embodiment of present invention; as shown in FIG. 18, the current turbine system 2810 comprises 9 dynamos 2820. Every three dynamos 2820 are grouped to be an obtuse triangle, and the obtuse triangle configuration is approximately arranged in horizontal level. So that the rotative axes of the rotor units 2840 might be approximately perpendicular to the water current.

### 29^{th} and 30^{th} Embodiment

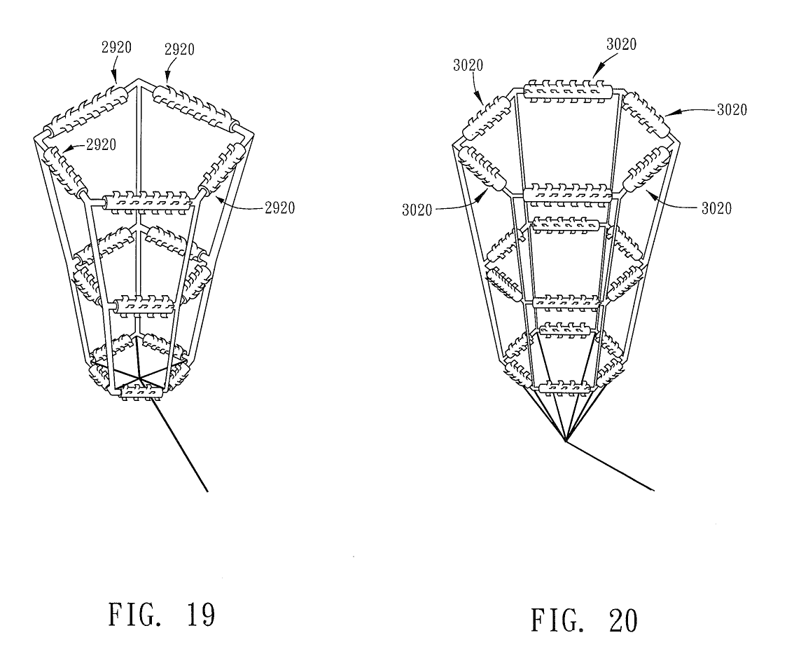

Please refer to FIG. 19 and FIG. 20, FIG. 19 is diagram of dynamos according to the 29^{th} embodiment of present invention; FIG. 20 is diagram of dynamos according to the 30^{th} embodiment of present invention. As shown in FIG. 19, every five dynamos 2920 are grouped to be pentagon; as shown in FIG. 20, every six dynamos 3020 are grouped to be hexagon.

### 31^{st} Embodiment

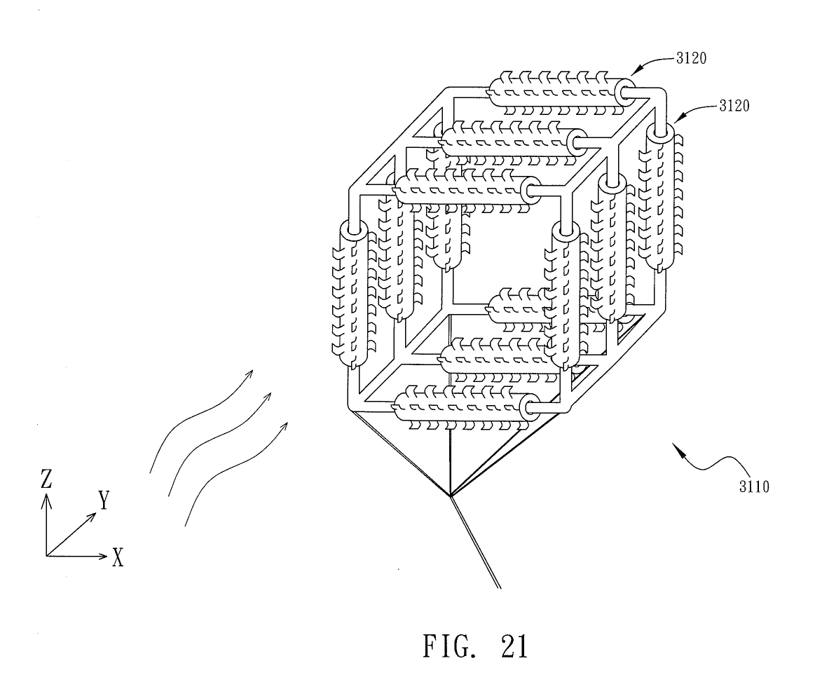

Please refer to FIG. 21, FIG. 21 is diagram of dynamos according to the 31^{st} embodiment of present invention; as shown in FIG. 21, the current turbine system 3110 comprises 12 dynamos 3120. Every four dynamos 3120 are vertically disposed and grouped to be a quadrilateral; the quadrilateral configuration is approximately perpendicular to the water current.

### 32^{nd} Embodiment

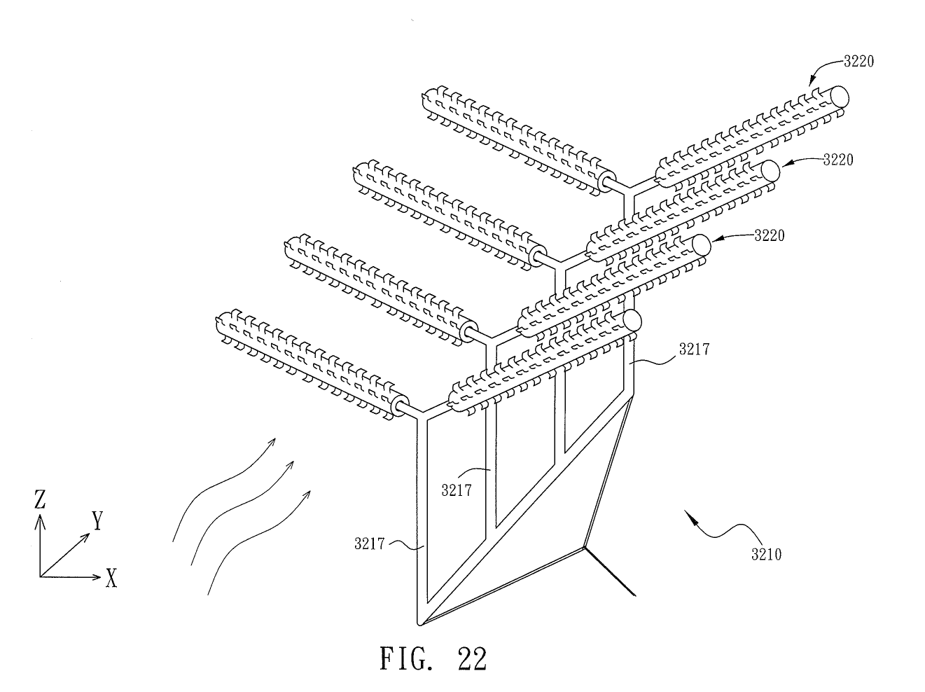

Please refer to FIG. 22, FIG. 22 is diagram of dynamos according to the 32^{nd} embodiment of present invention; as shown in FIG. 22, the current turbine system 3210 comprises 8 dynamos 3220. Every two dynamos 3220 are vertically disposed and grouped to be V-shaped; each holder 3217 is connected to the V-shaped configuration.

### 33^{rd} Embodiment

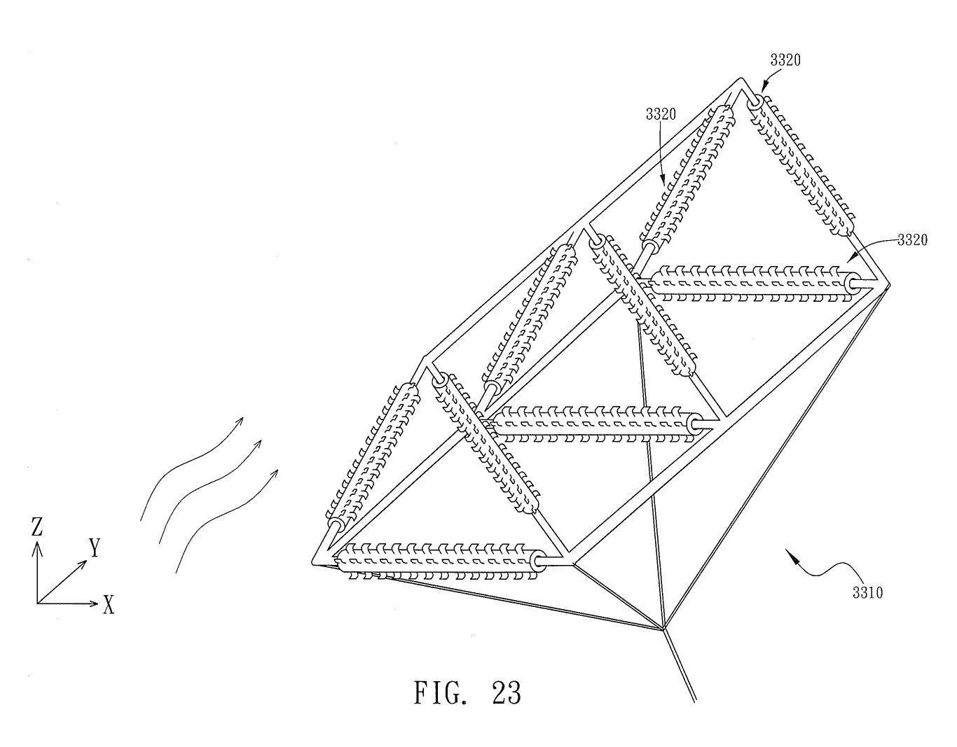

Please refer to FIG. 23, FIG. 23 is diagram of dynamos according to the 33^{rd} embodiment of present invention; as shown in FIG. 23, the current turbine system 3310 comprises 9 dynamos 3320. Every three dynamos 3320 are vertically disposed and grouped to be triangle; the water current is approximately perpendicular to the triangle configuration.

### 34^{th} Embodiment

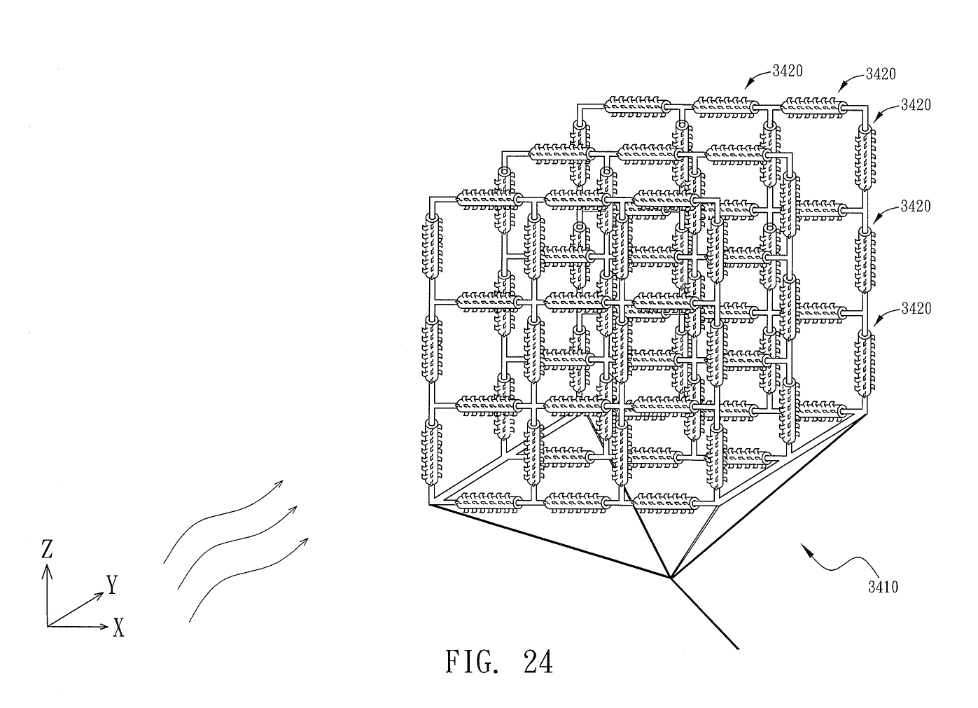

Please refer to FIG. 24, FIG. 24 is diagram of dynamos according to the 34^{th} embodiment of present invention; as shown in FIG. 24, the current turbine system 3410 comprises many dynamos 3420, in which those dynamos 3420 could be extended or disposed at X-coordinate, Y-coordinate or Z-coordinate by stacking. In this manner, the current turbine system 3410 may comprises dynamos 3420 as more as possible, and thus the generated electricity could also be maximized.

Next, the maintenance and the installation for the current turbine system are also vital. In this moment, manufacturing for the dynamo or current turbine system seems far easier than maintenance and installation; the reason is that maintenance and installation shall be progressed offshore or even underwater. Therefore the maintenance and installation may inevitably suffer erosion from salt water or difficulty from deep diving. So for now, no working dynamo or current turbine system is operated. In order to overcome these problems, the installation and maintenance method for installing and maintaining a current turbine system are disclosed. As shown in FIG. 25A˜25D, the current turbine system 110 comprises a fixing cable 111, a anchor structure 112, a halyard 113, a submarine cable 115 and pluralities of dynamos 120, in which each dynamo 120 contains at least one buoyant element (not shown) inside; wherein the buoyant element could be space as disclosed 12^{th}˜22^{nd} embodiments. In this manner, the dynamos 120 are able to float by means of the buoyant element. Two ends of the fixing cable 111 respectively connects to the dynamo 120 and the anchor structure 112; the end connecting to the anchor structure 112 could further couple to a submarine cable 115, so that the fixing cable 111 may conduct or transfer the generated electricity outward by means of passing through the submarine cable 115. Thus, the generated electricity may be eventually transferred to the grid in land. The fixing cable 111 could connect and suspend the dynamos 120 by means of directly connecting to the stator unit (not marked) or the holder 117. One end of the halyard 113 connects to a floating apparatus 114, in which the floating apparatus 114 is floated on the water surface; another end of the same halyard 113 connects to the anchor structure 112. In some embodiments, the buoyant element could be float ball or any object with density small than water; additionally, the buoyant element might also be disposed at inside or outside of the dynamo 120. Hence the dynamo 120 as a result can be floated by means of the buoyant element.

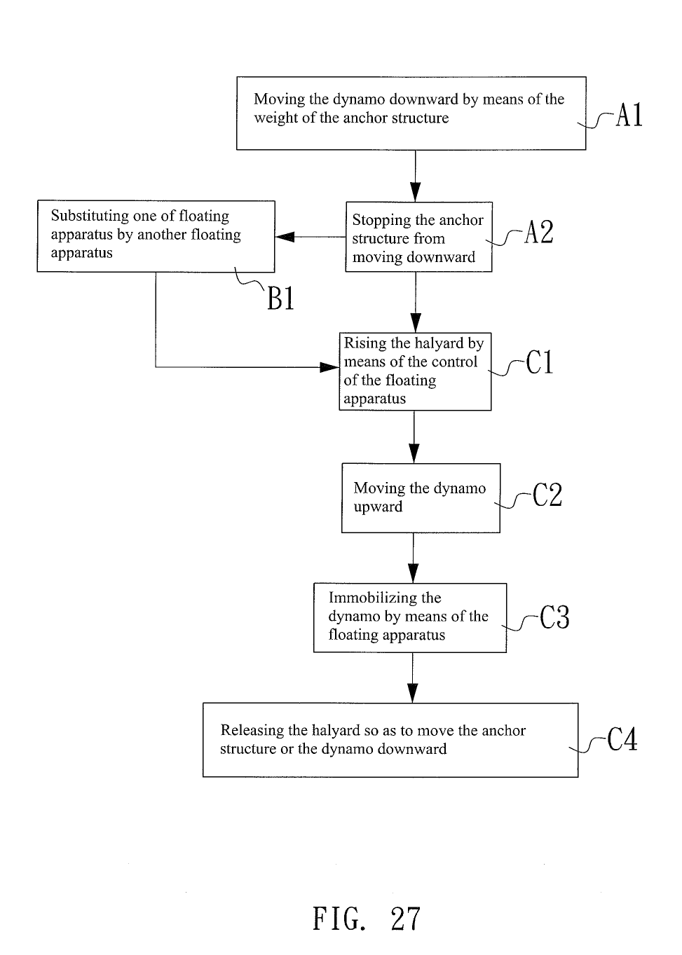

At the beginning, before installing the current turbine system 110, as shown in FIG. 25A, the dynamos 120 are floated at water surface; the floating apparatus 114 pull and hold the anchor structure 112 by means of the halyard 113, so as to prevent the anchor structure 112 from moving downward. Then the installation and maintenance method for installing and maintaining a current turbine system 110 have following steps. As shown in FIG. 27, Step A1: Moving the dynamo 120 downward by means of the weight of the anchor structure 112. When moving downward, it is shown in FIG. 25A˜25D, the floating apparatus 114 may adjust the releasing velocity of the halyard 113 or downward velocity of the anchor structure 112 by means of the control of a reel device(not shown), in which the reel device could be on the floating apparatus 114. Besides, the anchor structure 112 urges the fixing cable 111 or the dynamos 120 moving downward by means of weight of the anchor structure 112. Thus, in Step A1, the fixing cable 111 shall be driven downward by pulling force of the anchor structure 112, so as to urge the dynamos 120 moving downward. Moreover, the worker or technician in the floating apparatus 114 may easily control the rising or releasing of the halyard 113 by means of reel device, therefore the halyard 113 may have benefits of easy control for installation.

Next, Step A2: stopping the anchor structure 112 from moving downward; when the anchor structure 112 reaches the bottom of the water (e.g. seabed), the anchor structure 112 might slightly sink into the seabed; meanwhile the halyard 113 stops releasing and so that the dynamos 120 are suspended underwater (between water surface and seabed) by means of the upward buoyant force and the downward pulling force of the fixing cable 111. In this manner, the current turbine system 110 is able to be installed. Besides, the floating apparatus 114 could further equip with positioning system (not shown), so as to serve the worker or technician to detect the location of the dynamos 120 or floating apparatus 114; the halyard 113 might also conduct or transfer the generated electricity to the floating apparatus 114, so as to electrolyze water for production of oxygen, hydrogen or other chemical compositions in the floating apparatus 114; the halyard 113 might also have benefits to release the anchor structure 112 or the dynamos 120, or even help installation or maintenance for the dynamos 120.

Because that the floating apparatus 114 in Step A1 needs to bear or sustain the weight of dynamos 120, the floating apparatus 114 shall have big displacement (i.e. the amount of a liquid moved out from a ship), so as to provide sufficient buoyant force. However, big displacement means big ship and big cost. In this consideration, the installation and maintenance cost might be further reduced by means of changing the big-displacement floating apparatus 114 into a small-displacement floating apparatus 114. After changed, the remained function of the small-displacement floating apparatus 114 is to serve positioning or electrolysis. In order to change floating apparatus 114, the method further comprises Step B1: substituting one of floating apparatus 114 by another floating apparatus 114. Specifically, the substituting step could be after Step A2. Additionally, the term of “big-displacement” means that the floating apparatus 114 may provide sufficient buoyant force to raise the dynamos 120; the term of “small-displacement” means relatively smaller displacement than big-displacement. After the anchor structure 112 is stopped at bottom of water, the upper end of the halyard 113 may be then fixed or fastened to the small-displacement floating apparatus 114 by utilizing robot arm, clip or clamp. In this manner, the big-displacement floating apparatus 114 may therefore go to coast or carry out installation or maintenance for other current turbine system. In this method according to present invention, the Step B1 is an option; therefore substituting floating apparatus 114 might not be happened. Moreover, the small-displacement floating apparatus 114 could be tiny boat with GPS.

After the dynamos 120 work for some time, the maintaining problem is inevitable. In order to overcome this problem, the following Step C1 and Step C2 are disclosed. The Step C1: rising the halyard 113 by means of the control of the floating apparatus 114; Step C2: moving the dynamo 120 upward. The halyard 113 could be risen by means of reel device (not shown), so that the anchor structure 112 is hence moved upward. Meanwhile, the dynamos 120 may also move upward by means of the buoyant force, which is shown from FIG. 25D to FIG. 25A. When the dynamos 120 move upward until the neighboring of the floating apparatus 114 (near water surface), the Step C3 is carried out: immobilizing the dynamos 120 by means of the floating apparatus 114; then the dynamos 120 could be repaired or maintained at the floating apparatus 114 or near the floating apparatus 114. If the performance of dynamos 120 is so bad, they might be drawn or hauled to the land for maintenance. The immobilizing means for the dynamos 120 could be robot arm or tools equipped in floating apparatus 114.

When the maintenance is finished, the Step C4 is carried out: releasing the halyard 113 so as to move the anchor structure 112 or the dynamos 120 downward; therefore the dynamos 120 are re-installed underwater. In this manner, the Step C4 may have similar result with the Step A1˜A2.

Next, another embodiment regarding the installation and maintenance method is introduced. Please refer to FIG. 26A˜26D, FIG. 26A˜26D are diagrams of another installation and maintenance method for the current turbine system according to the present invention; as shown in FIG. 26A˜26D, lower end of the halyard 113 is connected to the dynamos 120. The halyard 113 could fix to the dynamos 120 by means of directly connecting to the stator unit (not marked) or the holder 117. In this manner, as disclosed in Step A1 and Step C4, the anchor structure 112 may draw or haul the fixing cable 111 and the dynamos 120 to move downward by means of weight of the anchor structure 112; and then the halyard 113 may reduce and control the downward velocity by means of slowly releasing. As disclosed in Step C1, the floating apparatus 114 may move the dynamos 120 and the anchor structure 112 upward by means of directly rising the halyard 113.

Summarily, the method of present invention may install pluralities of dynamos 120, may substitute the floating apparatus 114 by different-displacement floating apparatus, may maintain the dynamos 120 at the floating apparatus 114, may draw or haul the dynamos 120 to the land, and eventually may re-install the dynamos 120 into the underwater after maintenance. Therefore the drawback of underwater maintenance or deep sea work is prevented.

Next, the concept of pluralities sub-stators and pluralities sub-rotors may be adapted to the common dynamo; namely, pluralities of sub-rotors and sub-stators being concentrically disposed or axially disposed could also be utilized in common dynamo. Similarly, the magnetic components or winding components may be disposed at neighboring of the sub-rotor or at neighboring of the sub-stator, which could have similar configuration to the embodiments of FIG. 6A, 6C, 7A, 7C, 8A, 8C, 8D, 8E, 9A, 9C, 9D, 10A, 10C, 10D, 11A and FIG. 12A. The specific configuration is addressed below.

### 35^{th} Embodiment

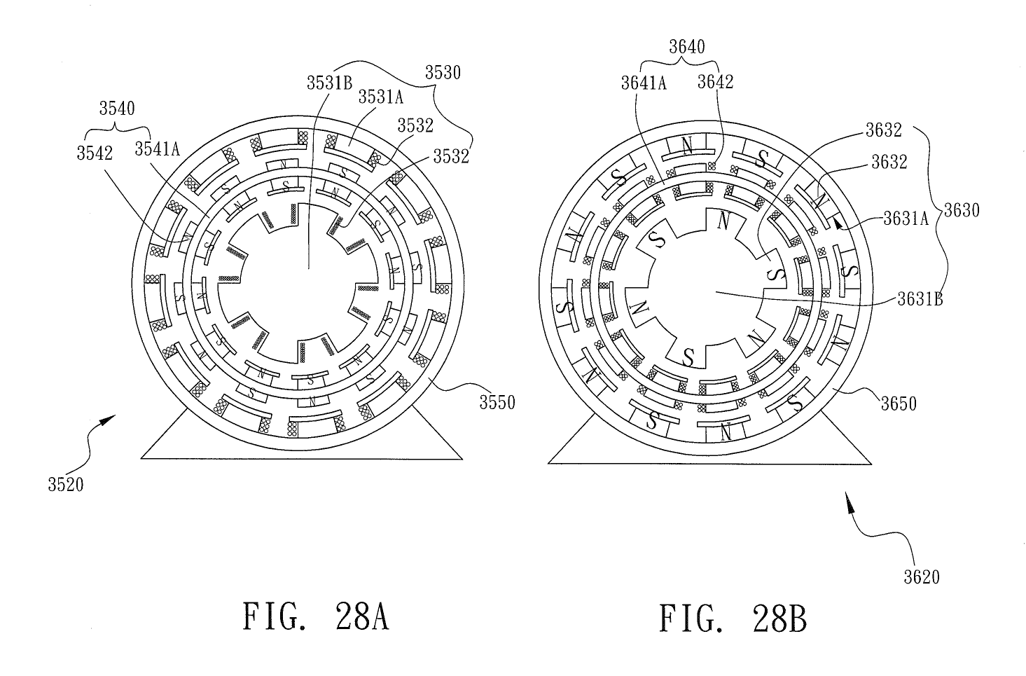

Please refer to FIG. 28A, FIG. 28A is diagram of dynamo according to the 35^{th} embodiment of present invention; as shown in FIG. 28A, a dynamo 3520 comprises a casing 3550, a rotor unit 3540 and a stator unit 3530. The rotor unit 3540 and the stator unit 3530 are both disposed inside the casing 3550. The stator unit 3530 contains a sub-stator 3531A and a sub-stator 3531B; the rotor unit 3540 contains a sub-rotor 3541A. The sub-stator 3531A, the sub-rotor 3541A and the sub-stator 3531B are orderly and concentrically disposed from outside to inside. The sub-stator 3531A is disposed at and near outside of the sub-rotor 3541A. The sub-stator 3531B is disposed at and near inside of the sub-rotor 3541A. The sub-stator 3531A and the sub-stator 3531B include pluralities of winding components 3532. The sub-rotor 3541A includes pluralities of magnetic components 3542, wherein the outward N poles and the inward N poles are alternately arranged at circumference of the sub-rotor 3541A. When the rotor unit 3540 rotates, the magnetic components 3542 of the sub-rotor 3541A may have relative motion to the winding components 3532 of the sub-stator 3531A or sub-stator 3531B, so that the electricity is generated. As aforementioned description, the magnetic component 3542 could be permanent magnet or excitation winding magnet. The magnetic components 3542 at inside and outside of sub-rotor 3541A may have opposite orientation; even more, the magnetism, disposition location or pole orientation of the magnetic component 3542 might also be changed.

### 36^{th} Embodiment

Please refer to FIG. 28B, FIG. 28B is diagram of dynamo according to the 36^{th} embodiment of present invention; as shown in FIG. 28B, a dynamo 3620 contains a casing 3650, a rotor unit 3640 and a stator unit 3630. The stator unit 3630 includes a sub-stator 3631A and a sub-stator 3631B. The rotor unit 3640 includes a sub-rotor 3641A. The rotor unit 3640 and the stator unit 3630 have similar configuration to the embodiment of FIG. 28A. In this embodiment, the sub-stator 3631A and the sub-stator 3631B both includes pluralities of magnetic component 3632. The outward N poles and the inward N poles are alternately disposed in order. Inside and outside of the sub-rotor 3641A both include pluralities of winding components 3642.

### 37^{th} Embodiment

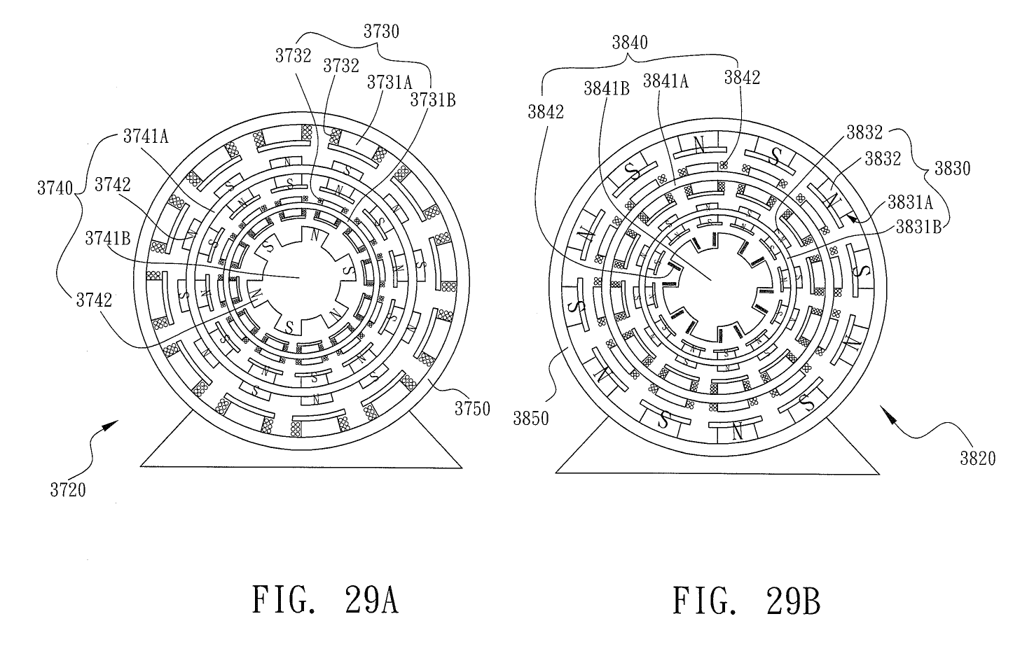

Please refer to FIG. 29A, FIG. 29A is diagram of dynamo according to the 37^{th} embodiment of present invention; as shown in FIG. 29A, a dynamo 3720 contains a casing 3750, a rotor unit 3740 and a stator unit 3730. The stator unit 3730 contains a sub-stator 3731A and a sub-stator 3731B. The rotor unit 3740 contains a sub-rotor 3741A and a sub-rotor 3741B. The sub-stator 3731A, sub-rotor 3741A, sub-stator 3731B and sub-rotor 3741B are orderly and concentrically disposed from outside to inside. The sub-stator 3731A and the sub-stator 3731B are respectively disposed at outside and inside of the sub-rotor 3741A, and near the sub-rotor 3741A. The sub-rotor 3741A and the sub-rotor 3741B are respectively disposed at outside and inside of the sub-stator 3731B, and near the sub-stator 3731B. The sub-stator 3731A and sub-stator 3731B could be composed of pluralities of winding components 3732. The sub-rotor 3741A and sub-rotor 3741B could be composed of pluralities of magnetic components 3742.

### 38^{th} Embodiment

Please refer to FIG. 29B, FIG. 29B is diagram of dynamo according to the 38^{th} embodiment of present invention; as shown in FIG. 29B, a dynamo 3820 contains a casing 3850, a rotor unit 3840 and a stator unit 3830. The stator unit 3830 contains a sub-stator 3831A and a sub-stator 3831B. The rotor unit 3840 contains a sub-rotor 3841A and a sub-rotor 3841B. The rotor unit 3840 and the stator unit 3830 have similar configuration to the embodiment of FIG. 29A. The sub-stator 3831A and the sub-stator 3831B both include pluralities of magnetic components 3832. The outward N poles and the inward N poles are alternately disposed in order. The sub-rotor 3841A and the sub-rotor 3841B both include pluralities of winding components 3842.

### 39^{th} Embodiment

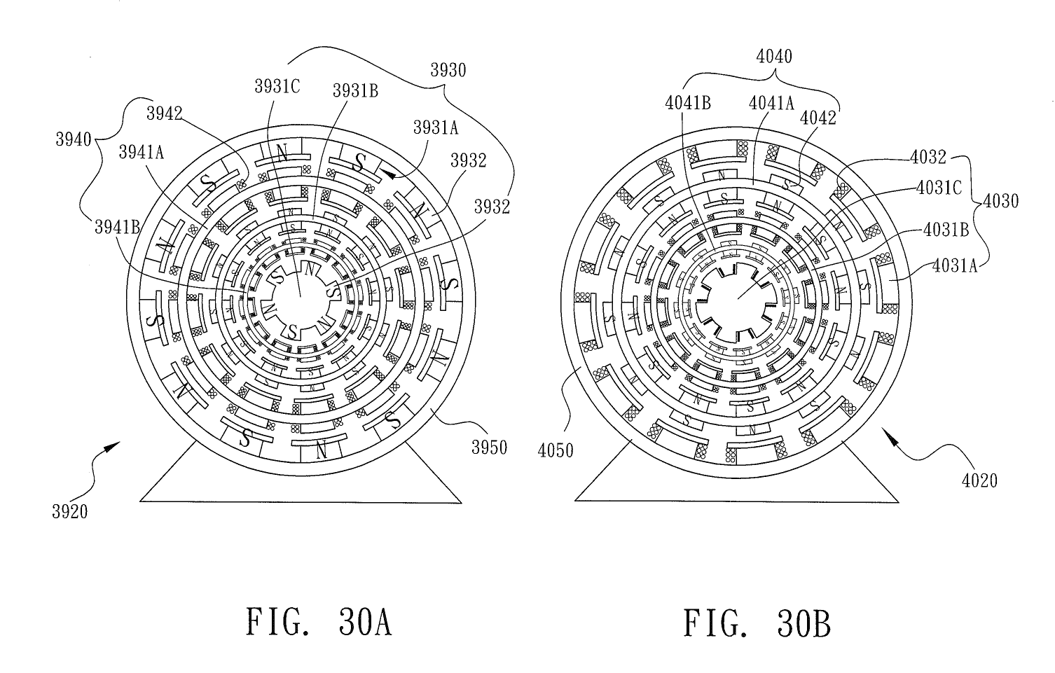

Please refer to FIG. 30A, FIG. 30A is diagram of dynamo according to the 39^{th} embodiment of present invention; as shown in FIG. 30A, a dynamo 3920 contains a casing 3950, a rotor unit 3940 and a stator unit 3930. The stator unit 3930 contains a sub-stator 3931A, a sub-stator 3931B and a sub-stator 3931C. The rotor unit 3940 contains a sub-rotor 3941A and a sub-rotor 3941B. The sub-stator 3931A, sub-rotor 3941A, sub-stator 3931B, sub-rotor 3941B and the sub-stator 3931C are orderly and concentrically disposed from outside to inside. The sub-stator 3931A and the sub-stator 3931B are respectively disposed at outside and inside of the sub-rotor 3941A, and near the sub-rotor 3941A. The sub-rotor 3941A and the sub-rotor 3941B are respectively disposed at outside and inside of the sub-stator 3931B, and near the sub-stator 3931B. The sub-stator 3931B and the sub-stator 3931C are respectively disposed at outside and inside of the sub-rotor 3941B, and near the sub-rotor 3941B. The sub-stator 3931A, the sub-stator 3931B and the sub-stator 3931C include pluralities of magnetic components 3932. The sub-rotor 3941A and the sub-rotor 3941B both include pluralities of winding components 3942.

### 40^{th} Embodiment

Please refer to FIG. 30B, FIG. 30B is diagram of dynamo according to the 40^{th} embodiment of present invention; as shown in FIG. 30B, a dynamo 4020 contains a casing 4050, a rotor unit 4040 and a stator unit 4030. The stator unit 4030 contains a sub-stator 4031A, a sub-stator 4031B and a sub-stator 4031C. The rotor unit 4040 contains a sub-rotor 4041A and a sub-rotor 4041B. The rotor unit 4040 and the stator unit 4030 have similar configuration to the embodiment of FIG. 30A. In this embodiment, the sub-stator 4031A, the sub-stator 4031B and the sub-stator 4031C include pluralities of winding components 4032. The sub-rotor 4041A and the sub-rotor 4041B both include pluralities of magnetic components 4042.

Summarily, in the 35^{th}˜36^{th} embodiment as shown in FIG. 28A˜28B, the number of the sub-stator is 2 and the number of the corresponding sub-rotor is 1; in the 37^{th} and 38^{th} embodiment as shown in FIG. 29A˜29B, the number of the sub-rotor is 2 and the number of the corresponding sub-stator is also 2; in the 39^{th} and 40^{th} embodiment as shown in FIG. 30A˜30B, the number of the sub-stator is 3 and the number of the corresponding sub-rotor is 2. As a result, a simple formula can be concluded from 35^{th}˜40^{th} embodiments: the number of sub-rotor inside a rotor unit is m; the number of the corresponding sub-stator inside a stator unit is n; and then the equation of m=n or n=m+1 are satisfied. If the number of the sub-rotor or the number of the sub-stator is more than or equal to 2, the sub-rotor and the sub-stator are alternately disposed. In this manner, the number of sub-rotor and the corresponding sub-stator may be as more as possible, so that the winding component and the magnetic component also can be disposed as more as possible. Therefore the generated electricity of the dynamo is maximized.

### 41^{st} Embodiment

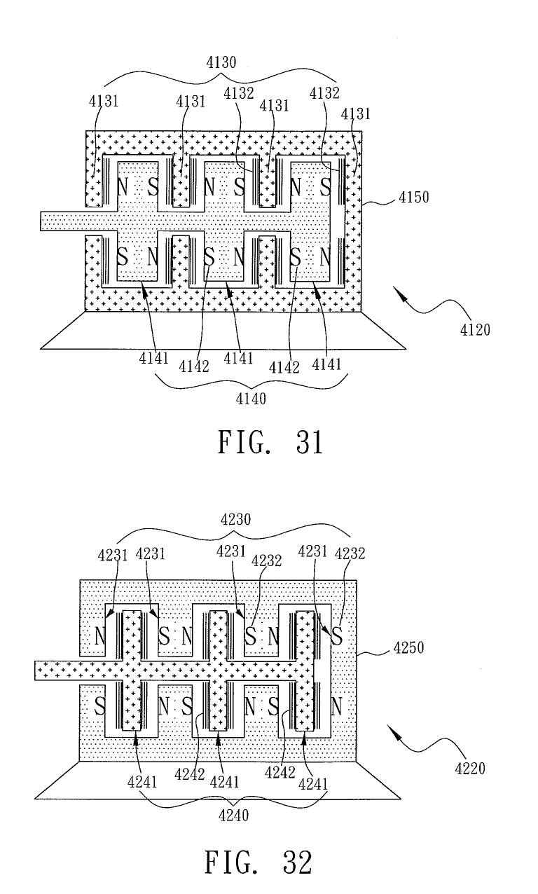

In the 35^{th}˜40^{th} embodiments, the sub-rotor and sub-stator are concentrically disposed. However, they might be axially disposed. Please refer to FIG. 31, FIG. 31 is diagram of dynamo according to the 41^{st} embodiment of present invention; as shown in FIG. 31, a dynamo 4120 contains a casing 4150, a rotor unit 4140 and a stator unit 4130. The rotor unit 4140 contains three sub-rotors 4141; those sub-rotors 4141 are axially disposed relative to the rotative axis of the rotor unit 4140, and may be rotated together. The stator unit 4130 contains four sub-stators 4131 disposed in axial direction. In this manner, those sub-stators 4131 and sub-rotors 4141 are both axially disposed. Moreover, each sub-rotor 4141 is adjacent to at least one sub-stator 4131, and each sub-stator 4131 is adjacent to at least one sub-rotor 4141.

Besides, the casing 4150 and the stator unit 4130 are one-body shaped (i.e. one piece) in FIG. 31; however, in other embodiment, the casing 4150 and the stator unit 4130 could be two distinct parts.

### 42^{nd} Embodiment

Please refer to FIG. 32, FIG. 32 is diagram of dynamo according to the 42^{nd} embodiment of present invention; as shown in FIG. 32, a dynamo 4220 contains a casing 4250, a rotor unit 4240 and a stator unit 4230. The rotor unit 4240 contains three sub-rotors 4241; the stator unit 4230 contains four sub-stators 4231. The sub-rotors 4241 and the sub-stators 4231 have similar configuration to the embodiment of FIG. 31.

Summarily, the dynamo and current turbine system of present invention may maximize the generated electricity, and may be suspend underwater. The installation and maintenance method may conveniently install and maintain a current turbine system or dynamos with relatively lower cost, so as to prevent the problem of deep sea work and underwater maintenance.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

I claim:

1. A current turbine system, comprising at least one dynamo; wherein each one of dynamo contains:
a rotor unit having rotative axis approximately perpendicular to the flow direction, and pluralities of disturbing elements disposed outside so that drag force relative to the current flow is formed, the rotor unit being driven to rotate when the current flow passes through the disturbing elements;
at least one stator unit;
at least one space disposed inside the rotor unit;
whereby the current turbine system may be suspended underwater.

2. The current turbine system as claim 1, wherein the disturbing element is protruded structure or concave structure.

3. The current turbine system as claim 1, wherein the current turbine system further comprises at least one fixing cable, one end of each fixing cable connecting to at least one stator unit, another end of the same fixing cable connecting to bottom of water.

4. The current turbine system as claim 3, wherein the fixing cable is connected to the bottom of water by means of an anchor structure.

5. The current turbine system as claim 4, wherein the current turbine system further comprises at least one halyard, one end of each halyard connecting to a floating apparatus floated on the water surface, and another end of the same halyard connecting to one of the stator unit or connecting to one of the anchor structure.

6. The current turbine system as claim 5, wherein the floating apparatus further contains a positioning system.

7. The current turbine system as claim 5, wherein the halyard conducts the electricity to the floating apparatus, or the halyard measures or detects the electrical property of the dynamo.

8. The current turbine system as claim 3, wherein at least one fixing cable connects to a submarine cable, so as to conduct the electricity to land.

9. The current turbine system as claim 1, wherein the rotor unit further contains at least one sub-rotor and the stator unit further contains at least one sub-stator, the sub-rotor rotating along with the disturbing elements, each sub-rotor being adjacent to at least one sub-stator and each sub-stator being adjacent to at least one sub-rotor; wherein the sub-rotor and the neighboring sub-stator are concentrically disposed relative to rotative axis of the rotor unit.

10. The current turbine system as claim 9, wherein the number of the sub-rotor of one rotor unit is m and the number of the sub-stator of the corresponding stator unit is n, wherein m=n or m=n+1 is satisfied.

11. The current turbine system as claim 9, wherein the sub-rotor and the sub-stator are alternately disposed if the number of the sub-rotor or the number of the sub-stator is more than or equal to 2.

12. The current turbine system as claim 1, wherein the rotor unit further contains at least one sub-rotor and the stator unit further contains at least one sub-stator, the sub-rotor rotating along with the disturbing elements, each sub-rotor being adjacent to at least one sub-stator and each sub-stator being adjacent to at least one sub-rotor; wherein the sub-rotor and the sub-stator are axially disposed relative to rotative axis of the rotor unit.

13. The current turbine system as claim 1, wherein the number of the dynamo is plurality.

14. The current turbine system as claim 13, wherein pluralities of dynamos are three dimensional structure and the current turbine system further comprises at least one fixing cable, one end of each fixing cable connecting to at least one stator unit, another end of the same fixing cable connecting to bottom of water.

15. The current turbine system as claim 14, wherein the dynamo with smaller volume of the space is disposed at lower level than the dynamo with greater volume of the space, or the dynamo with smaller buoyant force is disposed at lower level than the dynamo with greater buoyant force.

16. The current turbine system as claim 13, wherein at least one dynamo contains disturbing elements with different orientation comparative to another dynamo, or at least one dynamo has different rotative vector comparative to another dynamo.

17. The current turbine system as claim 1, wherein the dynamo contains a solid substance or liquid substance disposed inside, the solid substance or the liquid substance being able to evaporate gas.

18. A dynamo, comprising:
a rotor unit containing at least one sub-rotor;
a stator unit containing at least two sub-stators;
wherein each sub-rotor is adjacent to at least one sub-stator and each sub-stator is adjacent to at least one sub-rotor.

19. The dynamo as claim 18, wherein the number of the sub-rotor is m and the number of the sub-stator is n, wherein m=n or n=m+1 is satisfied.

20. The dynamo as claim 18, wherein the sub-rotor and the sub-stator are alternately disposed if the number of the sub-rotor or the number of the sub-stator is more than or equal to 2.

21. The dynamo as claim 18, wherein the sub-rotor and the sub-stator are axially disposed relative to rotative axis of the rotor unit, or the sub-rotor and the sub-stator are concentrically disposed relative to rotative axis of the rotor unit.

22. An installation and maintenance method for installing and maintaining a current turbine system, the current turbine system comprising at least one dynamo, at least one buoyant element, at least one fixing cable, at least one anchor structure and at least one halyard, the dynamo being able to float by means of the buoyant element, two ends of the fixing cable respectively connecting to the dynamo and the anchor structure, one end of the halyard connecting to a floating apparatus floated on the water surface, another end of the same halyard connecting to the dynamo or connecting to the anchor structure; the installation and maintenance method comprising:
moving the dynamo downward by means of the weight of the anchor structure;
stopping the anchor structure from moving downward;
whereby the dynamo is suspended underwater by means of the buoyant force and the pulling force of the fixing cable.

23. The installation and maintenance method as claim 22, wherein the method further comprises:
substituting one of the floating apparatus by another floating apparatus.

24. The installation and maintenance method as claim 22, wherein the method further comprises:
rising the halyard by means of the control of the floating apparatus;
moving the dynamo upward;
immobilizing the dynamo by means of the floating apparatus;
releasing the halyard so as to move the anchor structure or the dynamo downward;
whereby the dynamo is able to be repaired on the sea or drawn to the land by means of the floating apparatus, and then able to be re-installed to the sea.
